(19) United States
(12) Patent Application Publication
(10) Pub. No.: US 2011/0264494 A1
(43) Pub. Date: Oct. 27, 2011

(54) SYSTEM FOR AN INCENTIVE-BASED DISTRIBUTION OF A MARKETING MATERIAL

(76) Inventor: Stephen P. Lechowicz, Norwood (AU)

(21) Appl. No.: 13/090,133

(22) Filed: Apr. 19, 2011

(30) Foreign Application Priority Data
Apr. 19, 2010 (AU) 2010901641

(51) Int. Cl. G06Q 30/00

(52) U.S. Cl. 705/14.12

(57) ABSTRACT

The teachings are generally related to a system for an incentive-based distribution of a marketing material to a user, where the system can include, for example, multiple incentives for the user to view and understand the marketing material, such as gaming, competition, social networking, and rewards.

### CROSS-REFERENCE TO RELATED APPLICATIONS

This application claims the benefit of Australian Provisional Application No. 2010901641, filed Apr. 19, 2010, which is hereby incorporated herein by reference in its entirety.

### BACKGROUND OF THE INVENTION

1. Field of the Invention

The teachings are generally related to a system for an incentive-based distribution of a marketing material to a user, where the system can include, for example, multiple incentives for the user to view and understand the marketing material, such as gaming, competition, social networking, and rewards.

2. Description of the Related Art

With the increase in use of the internet, online advertising has become a seemingly attractive way to reach a large number of potential purchasers of a product or service. The promotions can be in many forms of marketing materials, such as a company website that discusses the company and products or services, for example. The challenge lies in getting viewers of the websites and other forms of marketing materials. Typically, the website is viewed because a potential purchaser has been given a direct reference to the website, or the potential purchaser has found the website in common searches performed by mainstream search engines, such as GOOGLE. Getting a desired amount of exposure on these search engines is a problem in itself. Websites are relatively easy to establish and maintain, and can potentially reach a large number of users. However, as there are numerous websites that can be viewed online, it may be difficult for a company to direct consumer traffic to their website.

A wide variety of creative ways of directing traffic has resulted in methods that potential purchasers now quite commonly believe is an annoyance or nuisance to their use of the internet. Advertising text, images, and banners are now a part of our normal internet environment, and so are “pop-ups,” all of which are unsolicited and tolerated by consumers at best. In addition, it's not uncommon for providers of email, news or search engine services to display advertisements for a range of products or services on otherwise “free” services. As many users access these websites, the advertisements are published to a larger market.

Users have become desensitized to advertising content, to say the least. Banner advertisements, pop-ups, and the bandwidth absorption that slows computer speed, and the like, have become a major pain-point for us to address in our society. Not only is the effectiveness of online advertising is diminishing, but advertisers are running out of ways to reach consumers without running the risk of being consider spam or otherwise harassing material. As such, an even bigger pain-point is that of the advertiser finding a way to reach the consumer in a way that is acceptable or even pleasing to the consumer, particularly for companies with limited marketing budgets. Moreover, consumers should also have a way to access marketing information on the internet without being force-fed with marketing material that is irrelevant to their interests, and untimely to their needs.

What is needed is system for marketing that is non-invasive to consumers and fruitful to advertisers, for example. One skilled in the art would appreciated having system directed to an incentive-based distribution of a marketing material to a user, where the system can include, for example, multiple incentives for the user to view and understand the marketing material, such as gaming, competition, social networking, and rewards. Such a system would help the promoter of marketing material reach the best consumers for their products and services, and the consumers can view and understand relevant and timely marketing packages in a forum that is entertaining, pleasing, and inviting to the consumer.

### SUMMARY

The teachings are generally related to an incentive-based distribution of a marketing material to a user, where the system can include, for example, multiple incentives for the user to view and understand the marketing material, such as gaming, competition, social networking, and rewards.

Generally speaking, one of skill will appreciate that the teachings provided herein are directed to a system for inducing an interest in a user in viewing and/or understanding a marketing material. In some embodiments, the system can include, for example, a game component, a competition component, and a reward component. The game component can comprise a core activity in which a user can participate, the core activity based on understanding at least a substantial amount of a marketing material. To stimulate competition, the competition component can include a function in which the user's performance is compared to the performance of another user. And, the reward component can include a function in which the user receives a reward based on the user achieving a desired level of performance. The system can also include a social component in which the user can communicate with another user having similar interests.

In some embodiments, the teachings can be directed to an incentive-based method of distributing marketing material to a user, the method comprising creating a game for a user to play based on understanding at least a substantial amount of a marketing material, wherein the game is a first incentive for the user to view and/or understand the marketing material in detail. In some embodiments, the method is a multi-incentive method that can include adding a competitive element to the game as a second incentive for the user to view and/or understand the marketing material in detail. In some embodiments, the method can include adding a social element to the game such as, for example, blogging, chatting, or social networking, as a third incentive. And, in some embodiments the method can include adding a step of providing a reward to the user for a performance in the competition as a fourth incentive for the user to view and/or understand the marketing material in detail. In a multi-incentive embodiment, for the example, the first, second, third, and/or fourth incentives can be used to encourage the user to view and/or understand at least the substantial amount of the marketing material.

Various characteristics of the user that is being targeted can be used to increase the effectiveness of the method. In some embodiments, the game can be designed for a particular demographic that could be predisposed to an interest in a product or service in the marketing material. And, in some embodiments, the game can be designed for a geographic region or regions, where the design is based on a similar targeted strategy.

Interaction with the system, and particularly with other users, can be used to create a more stimulating and effective environment to attract, retain, and develop a base of users. As such, in some embodiments, the competitive element can include, for example, an interactive environment that includes additional users in a competition. The competition can be a small, controlled group, a controlled-number in a group of a moderate to larger size, and this can be in an online environment. In some embodiments, the group can include, but is not limited to, an MMO (massively multiplayer online) environment.

Rewards can be used to attract, retain, and develop a base of users. As such, in some embodiments, the reward can comprises a value relating to a product or a service marketed in the game. The reward, for example, can be cash, product, discount, virtual, voucher, gift card, or any other reward that may suitably be provided through use of the systems and methods taught herein.

Social interaction and networking can be used to attract, retain, and develop a base of users. As such, in some embodiments, the method can further comprise a blog or chatroom, for example, for users. And, the systems taught herein can be coupled to existing social networks, such as FACEBOOK, TWITTER, or LINKED-IN, to name a few. In some embodiments, a competition, for example, can be coupled to a social networking environment.

The systems taught herein are well-suited for software-based systems. As such, the teachings are also directed to such a system for an incentive-based distribution of a marketing material to a user. These embodiments can include any one or any combination of software system components known to one of skill that could be used in implementing the methods in a computing system. In some embodiments, the systems include an input device, a processor, and the requisite memory operable to support a desired embodiment of the system. In some embodiments, the system includes a user-profile module embodied in a non-transitory computer readable storage medium for obtaining answers to questions from a user to establish a user profile for use in identifying the user's demographic. In some embodiments, the system includes a marketing material database embodied in a non-transitory computer readable storage medium for storing a user profile and a marketing material used in a competitive, social, and reward-based game for a user to play.

The games of the systems taught herein can be based on viewing and/or understanding at least a substantial amount of the marketing material, wherein the game can be a first incentive, the competition can be a second incentive, the social aspect can be a third incentive, and the reward can be a fourth incentive, for the user to view and/or understand the marketing material. In some embodiments, the system can also include a solutions module embodied in a non-transitory computer readable storage medium for identifying a user profile corresponding to the marketing material.

Particular goods and services can be matched to particular users through use of the user-profile. In some embodiments, the system can include an integration engine embodied in a non-transitory computer readable storage medium for matching the user demographic from the user profile to the marketing material. Likewise, an alignment module embodied in a non-transitory computer readable storage medium can be included for aligning the user to the competition and/or reward-based game through any way contemplated by one of skill. A gaming module embodied in a non-transitory computer readable storage medium is included for implementing the game.

The system, of course, can include an output module embodied in a non-transitory computer readable storage medium for providing information to the user. As such, the system can be an incentive-based distribution of a marketing material to a user, as well as a multi-incentive approach, wherein first, second, third, and/or fourth incentives, or a combination thereof, or more, can be used to encourage the user to view and understand at least the substantial amount of the marketing material.

The systems taught herein can be internet or network based. As such, in some embodiments, the system further comprises a browser module and/or a data exchange module. Moreover, the system can further comprise an external database for obtaining any of a variety of data from any of a variety of sources known to one of skill.

It should be appreciated that the system can be used worldwide, across national/international boundaries and language barriers. As such, in some embodiments, the system can further comprise a multilanguage database and translation engine. And, in view of the teachings provided herein, the game can be designed to, and/or targeted for, a particular demographic predisposed to an interest in a product or service in the marketing material.

### BRIEF DESCRIPTION OF THE FIGURES

FIG. 1 shows a general technology platform for the system for an incentive-based distribution of a marketing material, according to some embodiments.

FIG. 2 illustrates a processor-memory diagram to describe components of the system for an incentive-based distribution of a marketing material, according to some embodiments.

FIG. 3 is a concept diagram illustrating the system for an incentive-based distribution of a marketing material, according to some embodiments.

FIGS. 4A and 4B illustrate how a network may be used for an incentive-based distribution of a marketing material, according to some embodiments.

FIG. 5 provides a flowchart of an operation of the system, according to some embodiments.

FIG. 6 illustrates a screenshot of a purchasing page having a number of interactive objects, according to some embodiments.

FIG. 7 illustrates a screenshot of a task page, according to some embodiments.

FIG. 8 illustrates a screenshot of a registration webpage for a content provider (e.g., advertiser), according to some embodiments.

FIG. 9 illustrates a screenshot of the purchasing page of FIG. 6, according to some embodiments.

FIG. 10 illustrates a screenshot of a webpage containing options for the content provider, such as a size and a prize value for an interactive object, according to some embodiments.

FIG. 11 illustrates a webpage for choosing a name, URL, and the like, according to some embodiments.

FIG. 12 illustrates a webpage for editing interactive object options, according to some embodiments.

FIG. 13 illustrates a webpage for providing task elements to a content provider, according to some embodiments.

FIG. 14 illustrates a flowchart for receiving and embedding task elements, as well as providing electronic content, according to some embodiments.

FIGS. 15 and 16 illustrate screenshots of electronic content having task elements embedded in webpages, according to some embodiments.

FIG. 17 illustrates a registration page for a user of a game, according to some embodiments.

FIG. 18 illustrates a flowchart for use of the systems provided herein, according to some embodiments.

FIG. 19 illustrates a game space of interactive objects, according to some embodiments.

FIG. 20 illustrates a screenshot of the electronic content of a webpage relating to the selection of an interactive object, according to some embodiments.

FIG. 21 illustrates how the system may show a particular user that has achieved the highest points in a particular game, according to some embodiments.

### DETAILED DESCRIPTION

The teachings are generally related to an incentive-based distribution of a marketing material to a user, where the system can include, for example, multiple incentives for the user to view and understand the marketing material, such as gaming, competition, social networking, and rewards. Generally speaking, one of skill will appreciate that the teachings provided herein are directed to a system for inducing an interest in a user in viewing and/or understanding a marketing material. In some embodiments, the system can include, for example, a game component, a competition component, and a reward component. The game component can comprise a core activity in which a user can participate, the core activity based on understanding at least a substantial amount of a marketing material. To stimulate competition, the competition component can include a function in which the user's performance is compared to the performance of another user. And, the reward component can include a function in which the user receives a reward based on the user achieving a desired level of performance. The system can also include a social component in which the user can communicate with another user having similar interests.

It should be appreciated that the system can be of interest to a number of participants. The participants may include, for example, users, providers, and agents or representatives of users and/or providers. The providers, for example, can submit the marketing material that serves as the basis for a game played by users. A user, for example, may be anyone interested in playing a game offered by the system, and the user can be a private individual, business concern, or entity that has an interest in benefitting from viewing and/or understanding a marketing material. In addition, the providers of the marketing material also obtain a benefit of the marketing problems solved by the system. Both the providers and users can make contributions and receive benefits from the systems taught herein. A provider may include, for example, any business concern, individual, or entity that has marketing material that it would like user's to view and understand. Advertising agencies can represent, or service as, a provider in some embodiments.

The system can be a software-based service. It should be appreciated that the software can be purchased on a tangible medium, downloaded, or simply accessed in a streaming version from a cloud-computing space. And, it should be further appreciated that, in some embodiments, neither the user nor the service provider need to have more than minimal computing capability. As such, in some embodiments, the system is provided over a network. And, in some embodiments, the system is coupled to a network.

The terms “game” and “gaming” can be used to describe any diversion or activity that a user can engage in for any interest. The interest may be in having a simple diversion in an independent activity, a competitive activity, a reward-based activity, or a social activity. In some embodiments, the activity can be a task or tasks, regardless of whether independent, competitive, reward-based, or social. As such, in some embodiments, the game can involve a strategy for obtaining an end for the user, and the game can be for sport. In some embodiments, the game can be a competition conducted to follow a set of rules. The game can be a small contest, a large contest, or a division or preliminary round in a large contest or championship, such as an annual championship, in some embodiments. The game can be one of intellect, strategy, skill, risk, chance, or a combination thereof, in some embodiments. The game can be one of opportunity, such that a user should play the game to have any opportunity presented for a reward.

The term “reward” can be used to refer to many forms of reward, such as cash payment, discounts, a product or service, points, awards, badges, trophies, standing, titles, popularity, a “virtual” reward of any kind such as goods, money or tools for use while gaming, or merely the chance to continue the game or advance in some recognizable way. In some embodiments, the reward can result from being a winner or front-runner. In some embodiments, the reward can be one of chance, such that the reward can occur any time during play. In some embodiments, the reward occurs randomly and without forewarning and, in some embodiments, the user or user community is forewarned that a reward is, or will be, available. And, in some embodiments, the user or user community can be notified that one or more rewards had been received, and that they should continue play to receive a reward. In some embodiments, extended play is encouraged to discover items or information necessary to accomplish activities and receive a reward. Sometimes, the discovered items or information are at least a portion of the reward. In some embodiments, the systems taught herein are smart systems that calculate locations, times, and users with which to communicate regarding an offering of a reward for gaming.

The “marketing material” can be any material used in marketing or promoting a good, a service, a philosophy, a religion, a charity, academic subject, politics, any other message, or a general belief. The marketing material can be in any form of media, such as any one, or any combination, of text, audio, interactive application, or video. In some embodiments, the marketing material can be designed specifically for the game, or it can be a website; a set of website links; a user-created compilation of text, audio, or video; a download or series of downloads; or any combination thereof. In some embodiments, any one or any combination of communication channels can be used in playing a game. In some embodiments, a social network such as TWITTER, FACEBOOK, or LINKED-IN can be used alone or in combination to view and/or understand the marketing material, for example. In some embodiments, the use of these channels can be encouraged to gain hints, clues, and the like, about a game of interest.

In some embodiments, the teachings can be directed to an incentive-based method of distributing marketing material to a user, the method comprising creating a game for a user to play based on understanding at least a substantial amount of a marketing material, wherein the game is a first incentive for the user to view and/or understand the marketing material in detail. In some embodiments, the method is a multi-incentive method that can include adding a competitive element to the game as a second incentive for the user to view and/or understand the marketing material in detail. In some embodiments, the method can include adding a social element to the game such as, for example, blogging, chatting ,or social networking, as a third incentive. And, in some embodiments the method can include adding a step of providing a reward to the user for a performance in the competition as a fourth incentive for the user to view and/or understand the marketing material in detail. In a multi-incentive embodiment, for the example, the first, second, third, and/or fourth incentives can be used to encourage the user to view and/or understand at least the substantial amount of the marketing material.

Various characteristics of the user that is being targeted can be used to increase the effectiveness of the method. In some embodiments, the game can be designed for a particular demographic that could be predisposed to an interest in a product or service in the marketing material. And, in some embodiments, the game can be designed for a geographic region or regions, where the design is based on a similar targeted strategy. Such a strategy can include “location-based criteria” that can include, for example, the location of the player or players, as well as the location of the business entity that is offering the marketing material upon which the game is based. In some embodiments, a desired game can be located through a search directed to select players from a specific locality, whether region, city, state, country, or global region. In some embodiments, games can be desired and searched based on age, sex, ethnicity, religion, or political affiliation. In some embodiments, the game can be offered concurrently with a number of other games, where each game has one or more elements from one or more advertisers, so that the incentives for players and the attraction for different players with different interests is increased by consolidating elements and rewards from multiple advertisers.

Interaction with the system, and particularly with other users, can be used to create a more stimulating and effective environment to attract, retain, and develop a base of users. As such, in some embodiments, the competitive element can include, for example, an interactive environment that includes additional users in a competition. The competition can be a small, controlled group, a controlled-number in a group of a moderate to larger size, and this can be in an online environment. In some embodiments, the group can include, but is not limited to, an MMO (massively multiplayer online) environment.

Rewards can be used to attract, retain, and develop a base of users. As such, in some embodiments, the reward can comprises a value relating to a product or a service marketed in the game. The reward, for example, can be cash, product, discount, virtual, voucher, gift card, or any other reward that may suitably be provided through use of the systems and methods taught herein.

Social interaction and networking can be used to attract, retain, and develop a base of users. As such, in some embodiments, the method can further comprise a blog or chatroom, for example, for users. And, the systems taught herein can be coupled to existing social networks, such as FACEBOOK, TWITTER, or LINKED-IN, to name a few. In some embodiments, a competition, for example, can be coupled to a social networking environment.

The systems taught herein are well-suited for software-based systems. As such, the teachings are also directed to such a system for an incentive-based distribution of a marketing material to a user. These embodiments can include any one or any combination of software system components known to one of skill that could be used in implementing the methods in a computing system.

In some embodiments, the systems include an input device, a processor, and the requisite memory operable to support a desired embodiment of the system. In some embodiments, the system includes a user-profile module embodied in a non-transitory computer readable storage medium for obtaining answers to questions from a user to establish a user profile for use in identifying the user's demographic. In some embodiments, the user-profile can be limited, such that only the user's name is provided, and the name can optionally be fictional to maintain anonymity. In some embodiments, the systems provide a search engine that allows a user to identify games of interest according to any one or combination of several criteria to define the user's interest.

In some embodiments, the system includes a marketing material database embodied in a non-transitory computer readable storage medium for storing a marketing material used in a competitive, social, and reward-based game for a user to play. The games of the systems taught herein can be based on viewing and/or understanding at least a substantial amount of the marketing material, wherein the game can be a first incentive, the competition can be a second incentive, the social aspect can be a third incentive, and the reward can be a fourth incentive, for the user to view and/or understand the marketing material. In some embodiments, the system can also include a solutions module embodied in a non-transitory computer readable storage medium for identifying a user profile corresponding to the marketing material.

Particular goods and services can be matched to particular users through use of the user-profile. In some embodiments, the system can include an integration engine embodied in a non-transitory computer readable storage medium for matching the user demographic from the user profile to the marketing material. Likewise, an alignment module embodied in a non-transitory computer readable storage medium can be included for aligning the user to the competition and/or reward-based game through any way contemplated by one of skill. A gaming module embodied in a non-transitory computer readable storage medium is included for implementing the game. In some embodiments, the system provides the user with software development tools for changing or building a game dynamically so that the game is further tailored to the user. As such, having a combination of search options and software development tools, in some embodiments, allow a user great flexibility in locating, changing, or building a customized game dynamically.

The system, of course, can include an output module embodied in a non-transitory computer readable storage medium for providing information to the user. As such, the system can be an incentive-based distribution of a marketing material to a user, as well as a multi-incentive approach, wherein first, second, third, and/or fourth incentives, or a combination thereof, or more, can be used to encourage the user to view and understand at least the substantial amount of the marketing material.

The systems taught herein can be internet or network based. As such, in some embodiments, the system further comprises a browser module and/or a data exchange module. Moreover, the system can further comprise an external database for obtaining any of a variety of data from any of a variety of sources known to one of skill.

It should be appreciated that the system can be used worldwide, across national/international boundaries and language barriers. As such, in some embodiments, the system can further comprise a multilanguage database and translation engine. And, in view of the teachings provided herein, the game can be designed to, and/or targeted for, a particular demographic predisposed to an interest in a product or service in the marketing material.

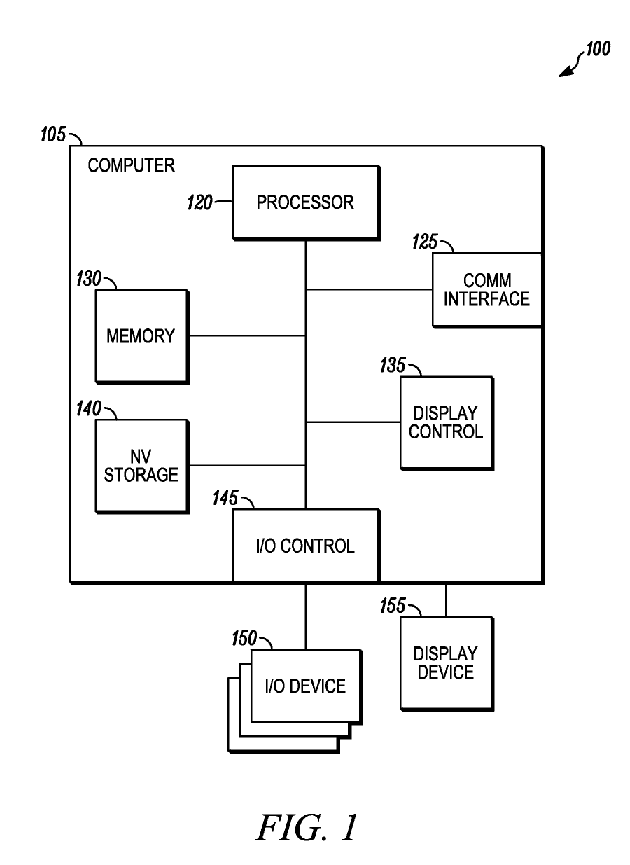

FIG. 1 shows a general technology platform for an incentive-based distribution of a marketing material, according to some embodiments. The computer system 100 may be a conventional computer system and includes a computer 105, I/O devices 150, and a display device 155. The computer 105 can include a processor 120, a communications interface 125, memory 130, display controller 135, non-volatile storage 140, and I/O controller 145. The computer system 100 may be coupled to or include the I/O devices 150 and display device 155.

The computer 105 interfaces to external systems through the communications interface 125, which may include a modem or network interface. It will be appreciated that the communications interface 125 can be considered to be part of the computer system 100 or a part of the computer 105. The communications interface 125 can be an analog modem, isdn modem, cable modem, token ring interface, satellite transmission interface (e.g. “direct PC”), or other interfaces for coupling the computer system 100 to other computer systems. In a cellular telephone, this interface is typically a radio interface for communication with a cellular network and may also include some form of cabled interface for use with an immediately available personal computer. In a two-way pager, the communications interface 125 is typically a radio interface for communication with a data transmission network but may similarly include a cabled or cradled interface as well. In a personal digital assistant, the communications interface 125 typically includes a cradled or cabled interface and may also include some form of radio interface, such as a BLUETOOTH or 802.11 interface, or a cellular radio interface, for example.

The processor 120 may be, for example, a conventional microprocessor such as an Intel Pentium microprocessor or Motorola power PC microprocessor, a Texas Instruments digital signal processor, or a combination of such components. The memory 130 is coupled to the processor 120 by a bus. The memory 130 can be dynamic random access memory (DRAM) and can also include static ram (SRAM). The bus couples the processor 120 to the memory 130, also to the non-volatile storage 140, to the display controller 135, and to the I/O controller 145.

The I/O devices 150 can include a keyboard, disk drives, printers, a scanner, and other input and output devices, including a mouse or other pointing device. The display controller 135 may control in the conventional manner a display on the display device 155, which can be, for example, a cathode ray tube (CRT), liquid crystal display (LCD), or plasma screen. The display controller 135 and the I/O controller 145 can be implemented with conventional well known technology, meaning that they may be integrated together, for example. In some embodiments, the output device can be operable for displaying the service-related information to the user.

The non-volatile storage 140 is often a FLASH memory or read-only memory, or some combination of the two. A magnetic hard disk, an optical disk, or another form of storage for large amounts of data may also be used in some embodiments, although the form factors for such devices typically preclude installation as a permanent component in some devices. Rather, a mass storage device on another computer is typically used in conjunction with the more limited storage of some devices. Some of this data is often written, by a direct memory access process, into memory 130 during execution of software in the computer 105. One of skill in the art will immediately recognize that the terms “machine-readable medium” or “computer-readable medium” includes any type of storage device that is accessible by the processor 120 and also encompasses a carrier wave that encodes a data signal. Objects, methods, inline caches, cache states and other object-oriented components may be stored in the non-volatile storage 140, or written into memory 130 during execution of, for example, an object-oriented software program.

The computer system 100 is one example of many possible t architectures. For example, personal computers based on an Intel microprocessor often have multiple buses, one of which can be an I/O bus for the peripherals and one that directly connects the processor 120 and the memory 130 (often referred to as a memory bus). The buses are connected together through bridge components that perform any necessary translation due to differing bus protocols.

In addition, the computer system 100 is controlled by operating system software which includes a file management system, such as a disk operating system, which is part of the operating system software. One example of an operating system software with its associated file management system software is the family of operating systems known as Windows Mobile®, Windows Phone®, Windows CE® and Windows® from Microsoft Corporation of Redmond, Wash., and their associated file management systems. Another example of operating system software with its associated file management system software is the LINUX operating system and its associated file management system. Another example of an operating system software with its associated file management system software is the PALM operating system and its associated file management system. The file management system is typically stored in the non-volatile storage 140 and causes the processor 120 to execute various acts for the operating system to input and output data and to store data in memory, including storing files on the non-volatile storage 140. Other operating systems may be provided by makers of devices, and those operating systems typically will have device-specific features which are not part of similar operating systems on similar devices. Similarly, iOS, ANDROID, WinCE® or PALM operating systems may be adapted to specific devices for specific device capabilities. A game console could be the computer system, for example, where the console is also any internet enabled game console known to one of skill including, but not limited to, an Xbox or PlayStation.

The computer system 100 may be integrated onto a single chip or set of chips in some embodiments, and typically is fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

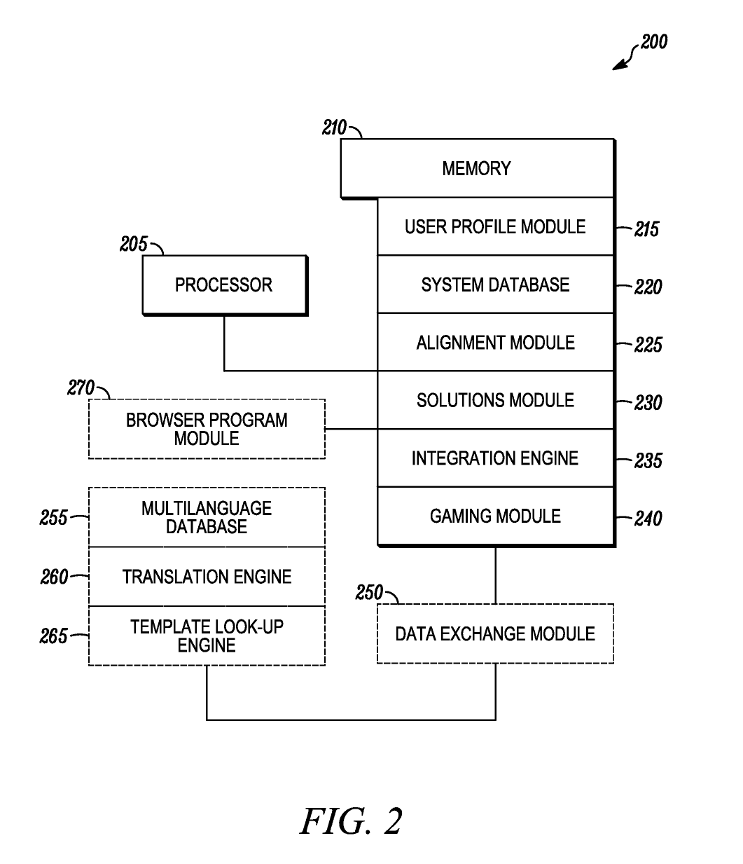

FIG. 2 illustrates a processor-memory diagram to describe components of an incentive-based distribution of a marketing material, according to some embodiments. The system 200 shown in FIG. 2 contains a processor 205 and a memory 210 (that can include non-volatile memory), wherein the memory 210 includes a user-profile module 215, a system database 220, an alignment module 225, a solutions module 230, an integration engine 235, and a gaming module 240.

The system can include an input device (not shown) operable to allow a user or service provider a way to enter into, or access information from, the system. In some embodiments, the input device can be operable for accepting user-oriented data. The user-oriented data can include a personalized user-profile. The user-oriented data can include information from answers to a template questionnaire from the user, and an identification of, for example, the interests and demographics of the user. In some embodiments, the user-oriented data can comprise one or more of the subject's age, sex, religion, ethnicity, location, personal interests, personal preferences, income, profession, education, and the like.

In some embodiments, the system can comprise a data exchange module embodied in a non-transitory computer readable storage medium for interacting with external data formats, wherein the user-oriented data can comprise external data obtained from another database, such as a social networking database. In some embodiments, the marketing material can be updated and extracted through other databases. As such, in some embodiments, the system can further comprise an external computer connection and a browser program module embodied in a non-transitory computer readable storage medium, wherein the browser program module accesses external data through the external computer connection to update the system database.

In some embodiments, the user-profile module 215 can be embodied in a non-transitory computer readable storage medium for receiving the user-oriented data. In some embodiments, the system can provide a set of data entry forms, surveys, screens and tools from which the system can receive information from users. In some embodiments, the system can access any of a variety of accessible data through an optional data exchange module, as discussed above. Likewise, the system database 220 can be embodied in a non-transitory computer readable storage medium and comprise a library of marketing material containing information relevant to the user-oriented data and can be supplemented or update through the browser module and/or data exchange module.

In some embodiments, the alignment module 225 can be embodied in a non-transitory computer readable storage medium for aligning the user-oriented data with a game from service database 220. Likewise, the solutions module 230 can be embodied in a non-transitory computer readable storage medium for identifying a user profile corresponding to the marketing material. The term “corresponding” can refer to any desired degree of match between the user and the marketing material. In some embodiments, the match can be about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 97%, about 99%, or about 100%. In some embodiments, the match can be greater than 95%, greater than 99%, or any range therein. In some embodiments, the match can be greater than 45%, greater than 65%, greater than 85%, or any range therein. In some embodiments, the match can be greater than 50%.

In some embodiments, the integration engine 235 can be embodied in a non-transitory computer readable storage medium for (i) integrating information between the information subsets; (ii) identifying any conflicting information; and (iii) matching the user profile to the marketing material.

The solutions module 230 can be operable to parse the relevant information in the system database 220 into information subsets. And, the integration engine 235 can be operable to integrate the user-profile with relevant information. In some embodiments, the relevant information can include conflicting information obtained from the system database 220. The system can then notify the user the conflicting information.

The gaming module 240 can be embodied in a non-transitory computer readable storage medium for implementing the game for the user. In some embodiments, the gaming format can include options for detailing the marketing material to the user-oriented data, such as type of good or service presented, as well as the color or environment which the good or service is presented, e.g., city, country, beach, etc. A graphical user interface (not shown) can be used to display data from the system to the user or the service provider.

As described herein, in some embodiments, the system can further comprise a data exchange module 250 operable to interact with external data formats. For example, the user-profile can comprise external data obtained from an advertiser's website, a series of websites, and the like.

In some embodiments, the system further comprises a multilanguage database 255, a translation engine 260, and a template look-up engine 265. The multilanguage database 255 can include a plurality of phrase templates associated with a plurality of phrases in the user profile and the system database. The translation engine 260 can be operable to translate the relevant phrase template from a source language to a destination language selected from multiple languages in the multilanguage database 255, and the template look-up engine 265 can be operable to find the phrase template associated with the destination phrase from among the multiple languages.

In some embodiments, the system further comprises a messaging module (not shown) operable to allow users to communicate with other users having like subject-profiles, or others users in a profile independent manner, merely upon election of the user. The users can email one another, post blogs, or have instant messaging capability for real-time communications. In some embodiments, the users have video and audio capability in the communications, wherein the system implements data streaming methods known to those of skill in the art.

The system can send alerts to users regarding games, competitions, and rewards, for example. Alerts can be pushed to any mobile device such that the user receives a text message in real time either through traditional SMS/MMS or other proprietary application-based messaging system that runs through the mobile devices OS. An example of an alert would be an appointment reminder sent to the mobile device. It should be appreciated that this can be done using real-time or near real-time functionality.

The systems taught herein can be practiced with a variety of system configurations, including any computing device, such as hand-held devices, personal computers, gaming consoles, multiprocessor systems, microprocessor-based or programmable consumer electronics, network PCs, minicomputers, mainframe computers, and the like. The teaching can also be practiced in distributed computing environments where tasks are performed by remote processing devices, portable, hand-held, or otherwise, that are linked through a communications network.

In some embodiments, the system further comprises an external computer connection and a browser program module 270. The browser program module 270 is operable to access external data through the external computer connection to update the service assessment database 220.

The system can have the capability of optimizing information as it learns, to create an optimized marketing environment, such that the information used to target users is updated on command, regularly, or constantly, for example, in some embodiments.

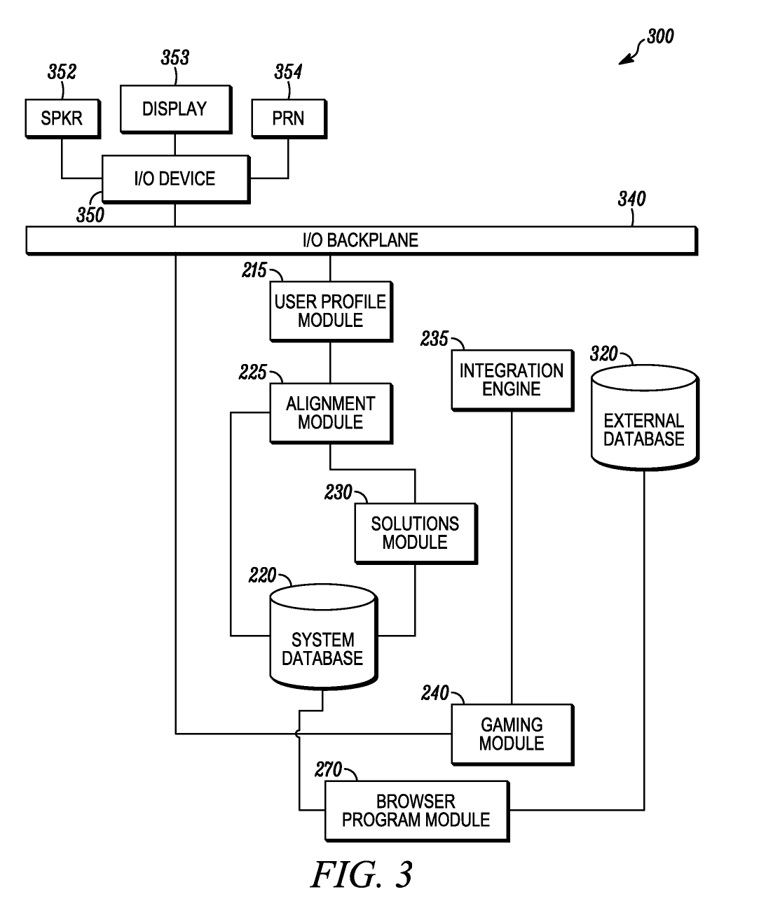

FIG. 3 is a concept diagram illustrating an incentive-based distribution of a marketing material, according to some embodiments. The system 300 contains components that can be used in a typical embodiment. In addition to the user-profile module 215, system database 220, the alignment module 225, the solutions module 230, the integration engine 235, and the gaming module 240 shown in FIG. 2, the memory 210 of the device 300 also includes the browser program module 270 for accessing the external database 320. The system includes a speaker 352, display 353, and a printer 354 connected directly or through I/O device 350 connected to I/O backplane 340.

The system can be implemented in a stand-alone device, rather than a computer system or network. In figure FIG. 3, for example, the I/O device 350 connects to the speaker (spkr) 352, display 353, and printer 354, but could also be coupled to other features. In a device offering language translation, the device can have a source language state selector and a destination language state selector connected directly to the I/O backplane 340. In many embodiments, the system can also have a mute/volume state selector connected directly to the I/O backplane 340. Other features can be added such as, for example, an on/off button, a start button, an ear phone input, and the like. In some embodiments, the system can turn on and off through motion. In some embodiments, the system can have a state selector to select a preprogrammed voice that is pleasing to the user.

It should be appreciated that a user can gain access to the system through any connection to the system that would be considered operable to one of skill. In some embodiments, the user is mobile, and the input device, the output device, or both, is provided through a portable, single unit device. And, in some embodiments, the device comprises a portable, single unit, handheld device. The handheld device can be, for example, a cell phone, smart phone, PDA, iPAD®, laptop computer, and the like.

As described herein, the system can include privacy measures. In some embodiments, the system further comprises security measures to protect the subject's privacy, integrity of data, or both. Such security measures are those well-known in the art such as firewalls, software, and the like. In addition, the system can be configured for use in an environment that supports administrative procedures and control. For example, the system can include an administrative module operable to control access, configure the engines, monitor results, perform quality assurance tests, and define audiences for targeting and trending. Since the system can safely be provided by a network and, in some embodiments, the system is coupled to a network, the security measures can help protect the contents of the system from external intrusions.

In some embodiments, the system is a web enabled application and can use, for example, Hypertext Transfer Protocol (HTTP) and Hypertext Transfer Protocol over Secure Socket Layer (HTTPS). These protocols provide a rich experience for the end user by utilizing web 2.0 technologies, such as AJAX, Macromedia Flash®, etc. In some embodiments®, the system is compatible with Internet Browsers, such as Internet Explorer®, Mozilla Firefox, Opera®, Safari®, etc. In some embodiments, the system is compatible with mobile devices having full HTTP/HTTPS support, such as iPhone®, PocketPCs®, Microsoft Surface®, video gaming consoles, and the like. In some embodiments, the system can be accessed using a Wireless Application Protocol (WAP). This protocol will serve the non HTTP enabled mobile devices, such as cell phones, BlackBerry® devices, etc., and provide a simple interface. Due to protocol limitations, the Flash animations are disabled and replaced with Text/Graphic menus. In some embodiments, the system can be accessed using a Simple Object Access Protocol (SOAP) and Extensible Markup Language (XML). By exposing the data via SOAP and XML, the system provides flexibility for third party and customized applications to query and interact with the system's core databases. For example, custom applications could be developed to run natively on iPhones®, Java® or .net-enabled platforms, etc. One of skill will appreciate that the system is not limited to the platforms discussed above and will be amenable to new platforms as they develop.

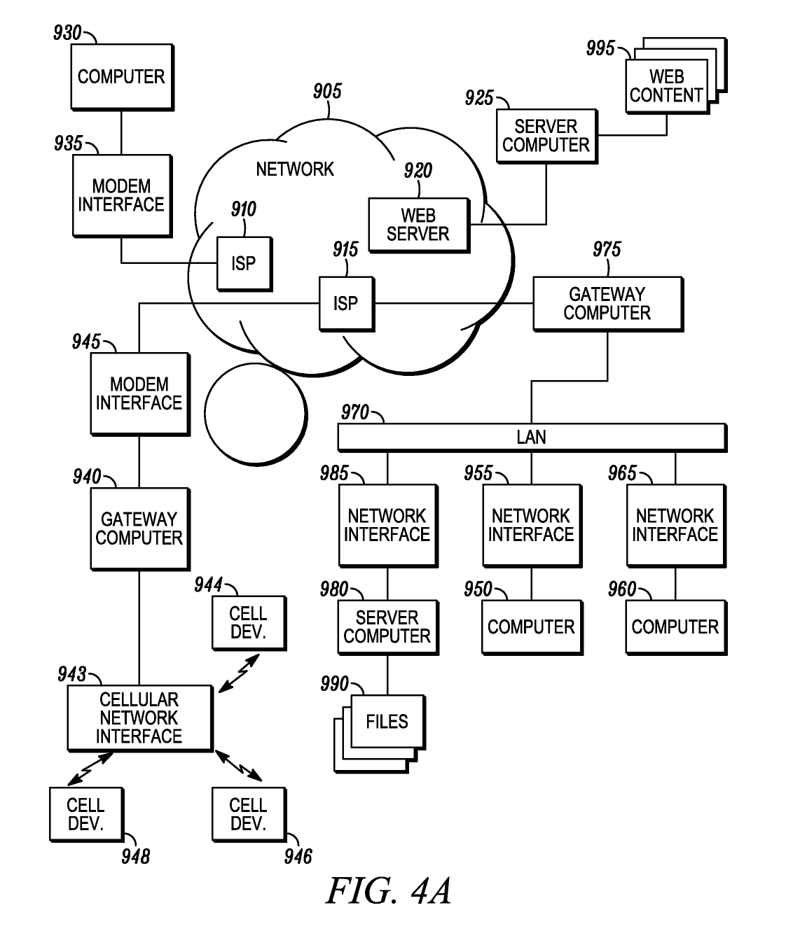

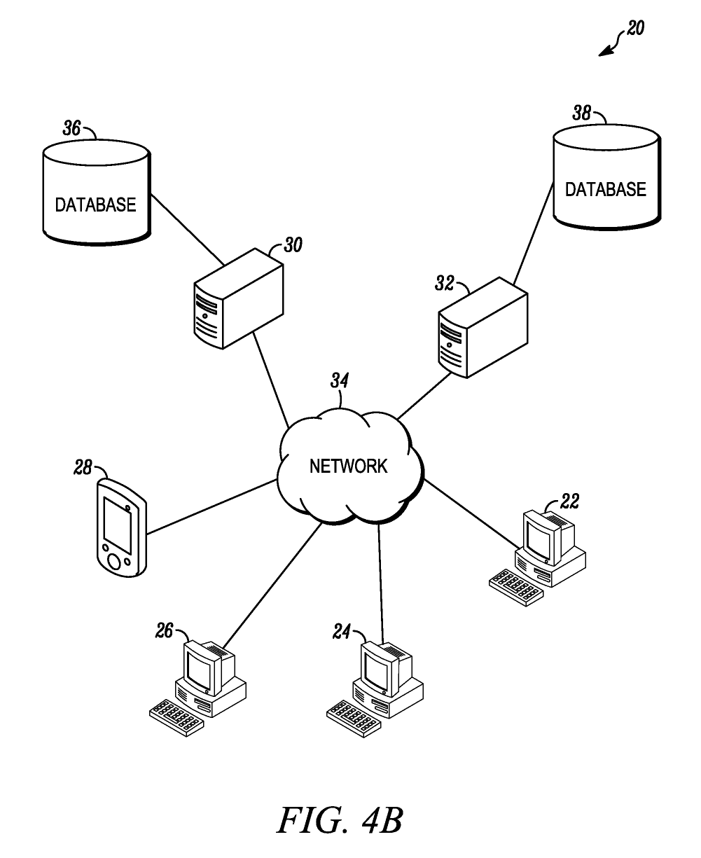

FIGS. 4A and 4B illustrate how a network may be used for an incentive-based distribution of a marketing material, according to some embodiments. FIG. 4A shows several computer systems coupled together through a network 905, such as the internet, along with a cellular network and related cellular devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 905 is typically provided by internet service providers (ISP), such as the ISPs 910 and 915. Users on client systems, such as client computer systems 930, 950, and 960 obtain access to the internet through the internet service providers, such as ISPs 910 and 915. Access to the internet allows users of the client computer systems to exchange information, receive and send e-mails, and view documents, such as documents which have been prepared in the HTML format. These documents are often provided by web servers, such as web server 920 which is considered to be “on” the internet. Often these web servers are provided by the ISPs, such as ISP 910, although a computer system can be set up and connected to the internet without that system also being an ISP.

The web server 920 is typically at least one computer system which operates as a server computer system and is configured to operate with the protocols of the world wide web and is coupled to the internet. Optionally, the web server 920 can be part of an ISP which provides access to the internet for client systems. The web server 920 is shown coupled to the server computer system 925 which itself is coupled to web content 995, which can be considered a form of a media database. While two computer systems 920 and 925 are shown, the web server system 920 and the server computer system 925 can be one computer system having different software components providing the web server functionality and the server functionality provided by the server computer system 925 which will be described further below.

Cellular network interface 943 provides an interface between a cellular network and corresponding cellular devices 944, 946 and 948 on one side, and network 905 on the other side. Thus cellular devices 944, 946 and 948, which may be personal devices including cellular telephones, two-way pagers, personal digital assistants or other similar devices, may connect with network 905 and exchange information such as email, content, or HTTP-formatted data, for example. Cellular network interface 943 is coupled to computer 940, which communicates with network 905 through modem interface 945. Computer 940 may be a personal computer, server computer or the like, and serves as a gateway. Thus, computer 940 may be similar to client computers 950 and 960 or to gateway computer 975, for example. Software or content may then be uploaded or downloaded through the connection provided by interface 943, computer 940 and modem 945.

Client computer systems 930, 950, and 960 can each, with the appropriate web browsing software, view HTML pages provided by the web server 920. The ISP 910 provides internet connectivity to the client computer system 930 through the modem interface 935 which can be considered part of the client computer system 930. The client computer system can be a personal computer system, a network computer, a web TV system, or other such computer system.

Similarly, the ISP 915 provides internet connectivity for client systems 950 and 960, although the connections are not the same as for more directly connected computer systems. Client computer systems 950 and 960 are part of a LAN coupled through a gateway computer 975. While FIG. 4A shows the interfaces 935 and 945 as generically as a “modem,” each of these interfaces can be an analog modem, isdn modem, cable modem, satellite transmission interface (e.g. “direct PC”), or other interfaces for coupling a computer system to other computer systems.

Client computer systems 950 and 960 are coupled to a LAN 970 through network interfaces 955 and 965, which can be ethernet network or other network interfaces. The LAN 970 is also coupled to a gateway computer system 975 which can provide firewall and other internet related services for the local area network. This gateway computer system 975 is coupled to the ISP 915 to provide internet connectivity to the client computer systems 950 and 960. The gateway computer system 975 can be a conventional server computer system. Also, the web server system 920 can be a conventional server computer system.

Alternatively, a server computer system 980 can be directly coupled to the LAN 970 through a network interface 985 to provide files 990 and other services to the clients 950, 960, without the need to connect to the internet through the gateway system 975.

Through the use of such a network, for example, the system can also provide an element of social networking, whereby users can contact other users having similar subject-profiles, or user can contact loved ones to forward the personalized information. In some embodiments, the system can include a messaging module operable to deliver notifications via email, SMS, and other mediums. In some embodiments, the system is accessible through a portable, single unit device and, in some embodiments, the input device, the graphical user interface, or both, is provided through a portable, single unit device. In some embodiments, the portable, single unit device is a hand-held device. As such, it can be appreciated that all social networks currently available over the internet, for example, can be used in conjunction with, coupled to, or otherwise operably integrated with, the systems taught herein. Such systems can include for example FACEBOOK, LINKED-IN, and TWITTER. FIG. 4B is discussed in Example 1 below.

### EXAMPLE 1

### The System and Methods of Using the System

User interaction with electronic content can be promoted using methods that include: storing information for a game; providing a user interface environment for playing the game, the user interface environment including one or more interactive objects for accessing electronic content from a content provider; receiving an interactive object selection from a user interacting with the user interface environment, the selection causing electronic content to be delivered to the user; determining that the user has completed a task associated with the delivered electronic content; and updating the game information on completion of the task. The delivered electronic content can include “a task element” for accessing the associated task. A task can be a game or a part of a game.

The user interface environment may provide a convenient way of directing a user to electronic content. Associating tasks with the delivered electronic content may encourage the user to engage with the delivered electronic content, leading to greater user interaction with the electronic content.

The game may include information that identifies or lists the interactive objects that form part of the game, and/or the status of the interactive objects. The status of an interactive object may depend on the status of the task or tasks associated with the electronic content delivered upon selection of the interactive object. For example, a task may have an “uncompleted”, “completed” or “x tasks completed” status. The game information may additionally or alternatively include information about users of the game and/or content providers associated with the electronic content accessed by an interactive object in the game. In this respect, the users of the game may be regarded as the game's “participants”. As will be explained in more detail later, in some embodiments participating in the game involves a user interacting with the user interface environment (such as a webpage) to access electronic content (such as a different webpage) delivered by selecting one of plural interactive objects displayed in the user interface environment.

The user interface environment may include a webpage or series of webpages, for example that may be provided in HTML format. In such an embodiment, the interactive objects may be displayed by viewing the user interface environment using a web browser, and thereby accessed by the user. Providing the user interface environment may involve communicating it across a network or electronic communications channel, such as a short message service (SMS) communication, email communication, a web-based communication, an instant messaging service communication, or a RSS or Twitter™ feed communication.

Although a web based user interface environment is an embodiment, it is possible that user interface environment may be a stand-alone executable program or application, or a digital file which is viewable using a third party program or application. Providing the user interface environment may involve transferring the program/file to the user via a computer readable media, such as a CD, DVD or USB drive or hard drive. The user interface environment could therefore be viewed online or offline. It is to be understood that the term “user interface environment” encompasses any means of displaying information, whether it be a webpage, a pop-up window, an electronic document, an image, or part of any of these displaying means. The electronic content associated with the interactive object may also include a webpage. The electronic content may thus be accessible via a URL or IP address and may be viewed using a web browser. Alternatively, the electronic content may include a file which is viewable using a third party program or application, such as a word processing file, or it may be a stand-alone executable program.

The electronic content may include a webpage of a company, providing information about the company's products or services. It may be an educational webpage providing information about a topic or theme, such as mathematics, music or the environment. The electronic content may relate to a particular industry, charity, culture or any other subject matter. Any electronic content may be associated with an interactive object.

Providing a task may involve providing a question, puzzle or test of skill for the user to complete. For example the task may be solving cross word questions, solving a formula or math problem, questions from student exams, general knowledge, specific product knowledge, a question from an IQ or mensa type test (such as image and pattern based puzzle), a quote from a specific page in a book or video, company information, or it could be a code obtained from a company, a clue found at a real physical location or a computer game requiring knowledge or dexterity (for example, chess, a driving simulator for a car maker, etc) or any other game where performance/success can be measured.

The task may be provided on a separate task page, or it may be provided in the user interface environment or in the electronic content. The task may be associated with the delivered electronic content by requiring the user to read the content in order to complete the task. For example, the user may want to search the electronic content to find the answer to a question. Alternatively, the task may be associated with the delivered electronic content by being accessible from the electronic content, for example via a task element, as will be described below.

Updating the game information may include updating the status of an interactive object in the game. It may include updating user information to record the completion of tasks by a particular user, or a “points score” for a particular user. Updating the game information may also include updating content provider information, such as recording game statistics for interactive objects accessing particular electronic content. The method may further include associating one or more task elements with each interactive object, each task element for incorporating (such as by embedding) in the electronic content delivered upon selection of the associated interactive object, and for activation by a user to complete a task. The task elements provide the means to access and complete tasks associated with the electronic content. The user may need to search the delivered electronic content to locate and activate the task element or task elements and thus complete the task. As such, the systems can include appropriate search engine functionality.

The delivered electronic content may thus incorporate one or more task elements in the form of a link (such as a URL), a control, a text box, a pop-up, a check box, a pull down list, or the like, each of which is activatable by the user to complete a task. It is to be noted that the format and/or protocol of the task element will depend on the type of electronic content.

Although a task element may be incorporated within the electronic content, it is also possible that a task element may be provided to a user separately from the electronic content. Hence, in some embodiments, a task element may not be incorporated with the electronic content but may nevertheless prompt the user to interact with the electronic content to complete the task. For example, a task element may be communicated to a user by email, an RSS or Twitter™ feed, or provided offline, such as on a hardcopy brochure or within product packaging.

The task element may include a hyperlink. This may be a convenient form for incorporating the task element in the electronic content by embedding the hyperlink in the associated source code. The method may then further include: determining that a task element has been activated; generating a task page for access by a user, the task page including activity instructions for completing a task; and associating an activity result with the task page; and wherein determining that the user has completed a task includes determining that the activity result is achieved by the user.

Thus, a task page may display the activity instructions for completing a task. Determining that the user has completed a task may include determining that the activity result is achieved by the user.

A task page may be a separate webpage, or it may be a pop-up window or image embedded in the electronic content or the user interface environment. In this respect, it is to be understood that the term “task page” encompasses any means of displaying information, whether it be a webpage, a pop-up window, an electronic document, an image, or part of any of these displaying means.

The task page may be generated for access by a user via a particular task element that uniquely identifies the location of the task page. Alternatively, generating a task page may include a user accessing the task page via a number of different task elements. Activation of a task element may cause any one of a number of possible task pages to be displayed. Thus a different task page may be displayed each time a task element is activated. Achieving the activity result may indicate successful completion of the task. The activity instructions may be a question, puzzle or test of skill. The activity instructions may relate to information contained in the electronic content. Thus, for example, the user may need to gather information from the electronic content in order to complete the task. This is expected to cause the user to engage with the electronic content. For example, if the electronic content includes a content provider's webpage, undertaking the task may educate the user about the content providers products or services. The activity instructions may include questions such as: “what is our most energy efficient configuration?”, “how much talk time do you get from one battery charge?”, “what is our latest coffee/burger/vitamin special offer?”. The activity instructions may encourage the user to gather information from a different source of electronic content. For example, the instructions may direct the user to another webpage or set of related webpages.

The activity instructions may encourage the user to visit a physical location, such as a store or showroom of the content provider, and speak to a person face to face. The answer to the activity instructions may be on a hardcopy brochure or business card provided at the content provider's store. This would enable content providers to encourage users to visit their premises. A user may be encouraged to find a clue at a certain time at a certain location, either online, on a television program or at a physical location.

Alternatively, the task may be completed simply by activating the hyperlink. For example, the task may be to find a task element hidden in the electronic content. Activating the hyperlink may indicate that the user has completed the task. Providing the task in this embodiment could therefore involve providing an instruction such as “Find a task element in the linked electronic content.” If the task elements are well concealed in the electronic content, finding and activating them may encourage the user to spend some time viewing the electronic content.

The task element may include executable code. For example, if the electronic content is a webpage, the code may be a javascript program or inline frame (iframe) that could be inserted into source code of the webpage, or that could access functionality at a server. The task could thus be displayed as a pop-up or within the electronic content.

Completion of a task associated with a task element may prompt entry of access codes or other information that may be made available in hardcopy(for example, in brochures or business cards). Such codes or information could be placed within products (for example, in the wrapper of an ice cream, under drink bottle lids or within cereal packets). This may introduce the concept of trading task elements or locations or information about interactive objects between users, which may add another dimension to the game. The method may further include enabling a content provider to purchase an interactive object and nominate electronic content to be associated with the interactive object; and providing the task elements associated with the purchased interactive object to the content provider to incorporate in the electronic content. This embodiment of the teaching may enable multiple content providers to participate in the one game. Content providers may purchase one or more interactive objects, which may be associated with the same or different electronic content. The task elements provided to the content provider may be hidden in the electronic content. This approach may provide a convenient way to perform online advertising.

The management of the user interface environment and updating the game information may be performed by a central controller, and the content provider need only insert the task elements into the source of information for users to access. A user may use the user interface environment to access electronic content associated with different content providers interactive objects.

To enable a user to find an interactive object of interest, the method may further include receiving advertising content from the content provider that purchased the interactive object; and associating the advertising content with the interactive object so that it is displayed in the interactive object. The advertising content may be a logo, image, video or other media provided by the content provider. It may be a 2D or 3D representation having any shape or format. The method may additionally or alternatively further include receiving one or more keywords from the content provider that purchased the interactive object; and associating the keywords with the interactive object. The user may therefore view the advertising content and/or search the keywords to identify interactive objects where they are interested in viewing the associated electronic content. This may lead to more targeted advertising, as users may gravitate towards particular interactive objects which relate to products or services of interest.

The method may further include enabling the content provider to modify tasks accessible using task elements associated with the interactive object. For example, where task pages are used, the method may include enabling the content provider to modify the activity instructions on the task page and the activity result associated with the task page. The content provider may thus set tasks that encourage the user to obtain information about their products or services, or to visit obscure parts of their websites.

A single content provider may provide the user interface environment to users, and may associate different electronic content with each interactive object. The different electronic content may relate to a different product or service provided by the content provider. The user interface environment may be provided as a webpage on a website of the content provider, and may encourage users to visit and read other webpages in the website. A user's knowledge about the content provider, and accordingly their likelihood of purchasing a product or service, may thus be increased.

The user interface environment may include a webpage and the one or more interactive objects may be one or more “game spaces” on the webpage, each game space including a user selectable region. This may provide a convenient way of viewing the interactive objects.

Each game space may have a size, and the method may further include setting a purchase price for each interactive object that is proportional to the size of the interactive object. For example, the price may be related to the number of pixels in the interactive object. This means that content providers can pay more for a larger interactive object in which to display their advertising content.

The game spaces in the user interface environment may be arranged to fit into a geometrical shape, such as a square, rectangle, circle, sphere, cube or other geometrical shape or combination of shapes. Alternatively, the game spaces may be placed in a computer generated landscape or representation of space or an underwater or other environment.

The user interface environment may be a webpage and the one or more interactive objects may be one or more links listed on the webpage. The list of links may be provided in response to a search query entered into the user interface environment by a user. The user may thus be presented only with links of potential interest. This is advantageous in circumstances where there are a large number of interactive objects to choose from.

The method may include making the user interface environment available online, for access by a plurality of users. This approach may increase the number of viewers and users of the user interface environment, which may be beneficial where the electronic content is nominated by content providers. Alternatively, the user interface environment may be provided to users individually, and may be linked to electronic content stored at the user's computer. Therefore, the method may take place wholly offline.

Updating the game information may include recording an identity of the user and a points score for the user that completed the task associated with the delivered electronic content. The amount of points allocated to a user may be based on one or more of the following;

first user to complete a task;

first user to select a particular interactive object;

speed of completing a task;

difficulty of a task completed;

quality of an answer given in completion of a task;

type of task; and

number of users who have previously completed a task.

Users can thereby compete to gain the greatest number of points for an interactive object. This may encourage users to try to maximize their points score by searching for as many task elements as possible in the electronic content, or spending more time in research in order to provide a higher quality answer to a task.

The method may further include setting a reward for each interactive object. The reward may be awarded to the user with the highest points score for the interactive object after a defined period of time. This may encourage the user to continue trying to better their score within the period of time. In one example, the period of time may be 30 days. Alternatively, the reward may be awarded to the user who is the first to obtain a certain points score, first to access the electronic content, or to obtain any other defined achievement.

The reward may be a monetary amount. Where the interactive object is purchased by a content provider, the monetary amount may be proportional to the purchase price of the interactive object. The reward may alternatively be a free product or service, a discount voucher, an opportunity to win a monetary amount, or any other benefit. The purchase price set for an interactive object may be proportional to the reward.

The method may further include awarding an ‘instant prize’ for a particular interactive object at a particular time. Users who win a reward on their birthday may be awarded a bonus reward. For students there may be an offer to double the reward if it is put into an educational trust fund for their tuition.

According to another aspect, the teachings provide a method of providing online advertising content including:
storing information for a game;
enabling a content provider to purchase an interactive object for display in a user interface environment for playing the game, and nominate electronic content to be associated with the interactive object so that selection of the interactive object by a user interacting with the user interface environment causes the electronic content to be delivered to the user;
associating one or more task elements with the interactive object;
providing the task elements to the content provider to incorporate in the electronic content for activation by a user to complete a task;
determining that a user has completed a task associated with a task element; and
updating the game information on completion of the task.

According to another aspect, the teachings provide software for use with a computer including a processor and associated memory for storing the software, the software including a series of instructions executable by the processor to carry out the method in accordance with any one of the embodiments described above.

The teaching also extends to a computer readable media containing the software, and a central controller server including a processor, a memory and software resident in memory accessible to the processor, the software including a series of instructions executable by the processor to carry out the method in accordance with any one of the embodiments described above.

According to another aspect, the teachings provide a method of promoting user interaction with electronic content including;
a content provider receiving one or more task elements associated with an interactive object for display in a user interface environment for playing a game;
incorporating the task elements in electronic content for delivery to a user on selection of the associated interactive object from the user interface environment; and
providing the electronic content to a user;
wherein game information associated with the interactive object is updateable in response to the completion by the user of a task accessed by activating one of the task elements.

The teaching extends to a content provider server including a processor, a memory and software resident in memory accessible to the processor, the software including a series of instructions executable by the processor to carry out this method. The teachings also extends to a system including a central controller server and a content provider server as described above.

### EXAMPLE 2

### A Network

A variety of network configurations are possible. The network 20 shown in FIG. 4B includes one or more client processing systems and one or more server processing systems. In this example, the client processing systems include personal computers (PCs) 22, 24 and 26 and hand held device 28.

The server processing systems include central controller server 30 and content provider server 32. The client and server processing systems 22-32 are connected via the network 34. The central controller server 30 and content provider server 32 can facilitate the transfer of data between the network and one or more databases, such as databases 36 and 38 respectively. The central controller server 30 runs software that presents webpages to a participant according to their participant type.

### EXAMPLE 3

### Storing Game Information

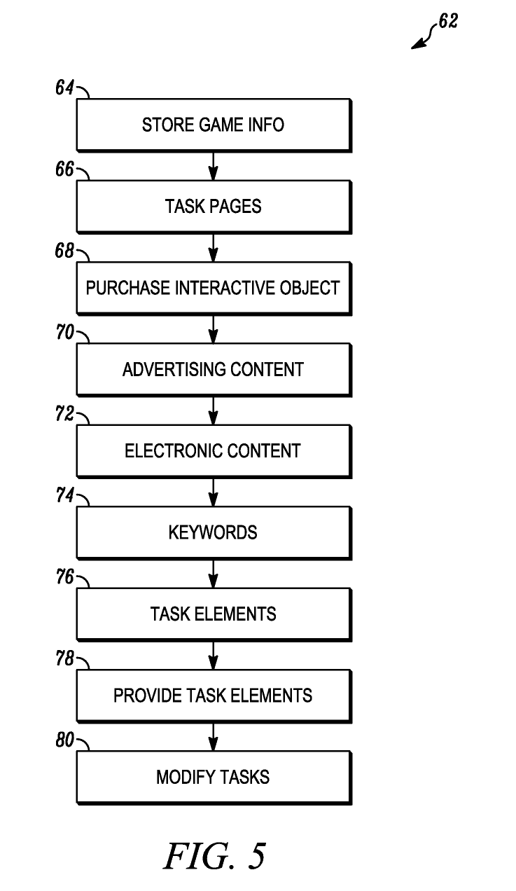

FIG. 5 provides a flow chart of an operation of the system, according to some embodiments. The central controller server 30 may run software including a series of instructions for performing a method 62 as shown in FIG. 5. At step 64, the software stores game information.

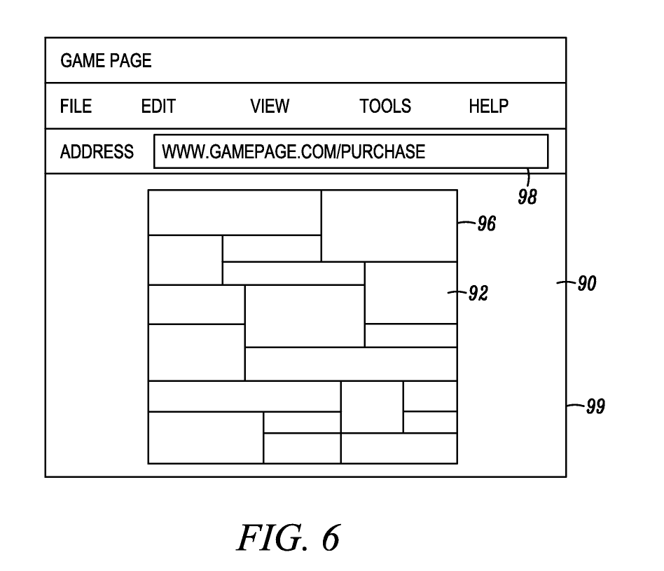

FIG. 6 illustrates a screenshot of a purchasing page having a number of interactive objects, according to some embodiments. In this embodiment, the game information includes a number of game pages, such as game page 90 shown in FIG. 6. Game page 90 is a webpage that is stored in database 36 and served by content provider server 30. Game page 90 has 19 game spaces, e.g. spaces purchased by one or more content providers, including game space 92. The game spaces define areas on the game pages where interactive objects will appear when the game is presented to players.

The game spaces on the game page 90 have rectangular or substantially rectangular shapes and are arranged to fit into a larger rectangular shape 96. Other game pages stored may have different numbers of game spaces (for example, up to 500 game spaces on one game page), and the game spaces may be arranged in different geometrical shapes, 2D or 3D landscapes, among scenery, space, a world map or other environments.

The central controller server 30 may, in the game information, designate certain game pages as being game pages for certain company or product types, or the game pages may be unrestricted. The central controller server 30 may also limit use of the game pages to users in a particular geographical region. Keywords may be associated with each game page in order to identify a game page of interest.

### EXAMPLE 4

### Storing Task Pages

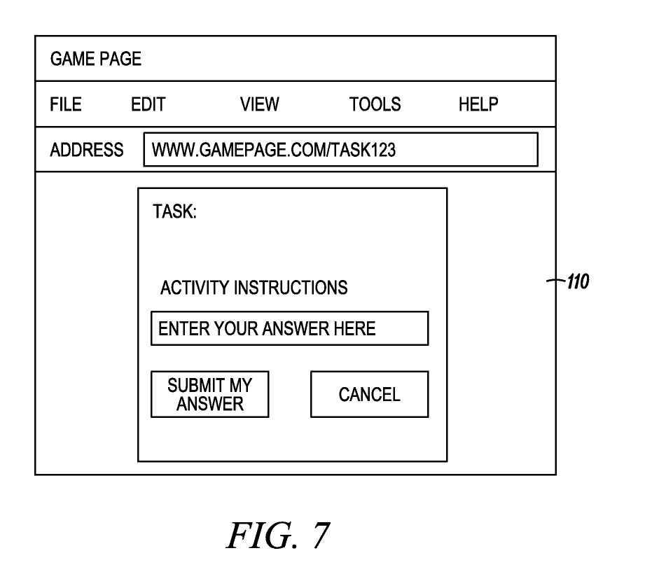

FIG. 7 illustrates a screenshot of a task page, according to some embodiments. At step 66 of FIG. 5, the software generates one or more such task pages. Each task page can provide activity instructions, such as one or more clues, questions, puzzles, tasks or tests of skill for a user to complete. The clues, questions, puzzles, tasks or tests of skill can be of varying degrees of difficulty and/or complexity. The task pages may be indexed by various criteria including but not limited to difficulty, discipline (e.g. mathematics, education, music etc), content/media type (e.g. interactive application, video, question, puzzle, image etc), theme (e.g. charity, environment etc), keywords, language, region (i.e. if it related to a particular region), culture (i.e. if it related to a particular culture), industry and/or user demographic.

An activity result is associated with each task page, which defines what could be achieved by the user to complete the task. For example, where the task is a question, the activity result would be the answer to the question.

The task page may be configured differently for different task types. A text based task may have a text area of some size, an image/video/application based task may have a portion of the page devoted to displaying the image/video/application. Task pages may also contain a number of task-options at different difficulty levels and worth different points.

### EXAMPLE 5

### Purchasing Interactive Objects

The software enables purchase of an interactive object at step 68. In this embodiment, an interactive object is a game space that has an associated link, for accessing electronic content. The interactive object is created and presented to users of the game, based on criteria set by the purchasing content provider.

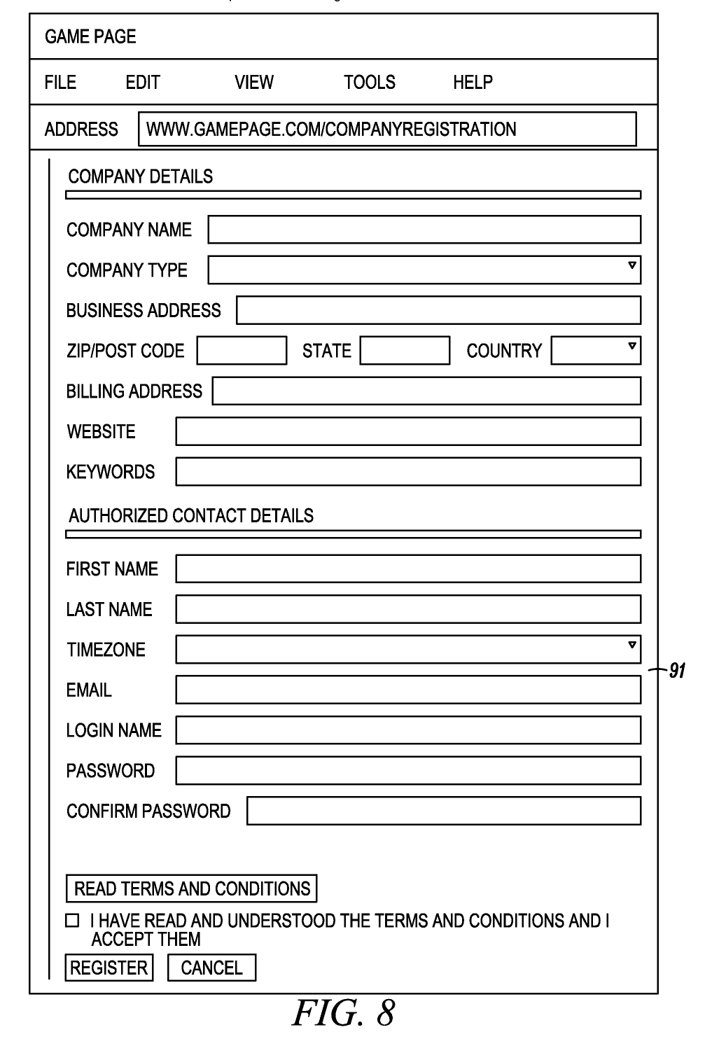

FIG. 8 illustrates a screenshot of a registration webpage for a content provider (e.g., advertiser), according to some embodiments. A company that wishes to purchase an interactive object may access the website of the central controller server 30 using a web browser on their personal computer 22. The company may register as a content provider, using the registration webpage 91 shown in FIG. 8. Registration allocates the content provider a user name and password, for use in accessing the website in the future.

Once the content provider has logged in, the central controller server 30 allows the content provider to purchase an interactive object. If the game pages have been indexed, the content provider may conduct a keyword search for an appropriate game page. This could be a search of keywords listing product or company types, or a search for a particular design of the game page. The content provider may search for and rank game pages according to their own criteria. For example, a content provider may wish to purchase an interactive object that is a game space which fits in a geometrical shape and is near to a game space purchased by their competitor. Alternatively, the content provider may wish to purchase all of the game spaces on a game page.

The purchase price for each game space may be set to be proportional to the size of the game space. For example, the game spaces on a game page may have a total area of 2000×2000 pixels=4,000,000 pixels, and the purchase price for the game space may be $1 per pixel. The purchase price for each game space may also be dependent on the game page. For example, there may be high value games at a cost of $100 per pixel.

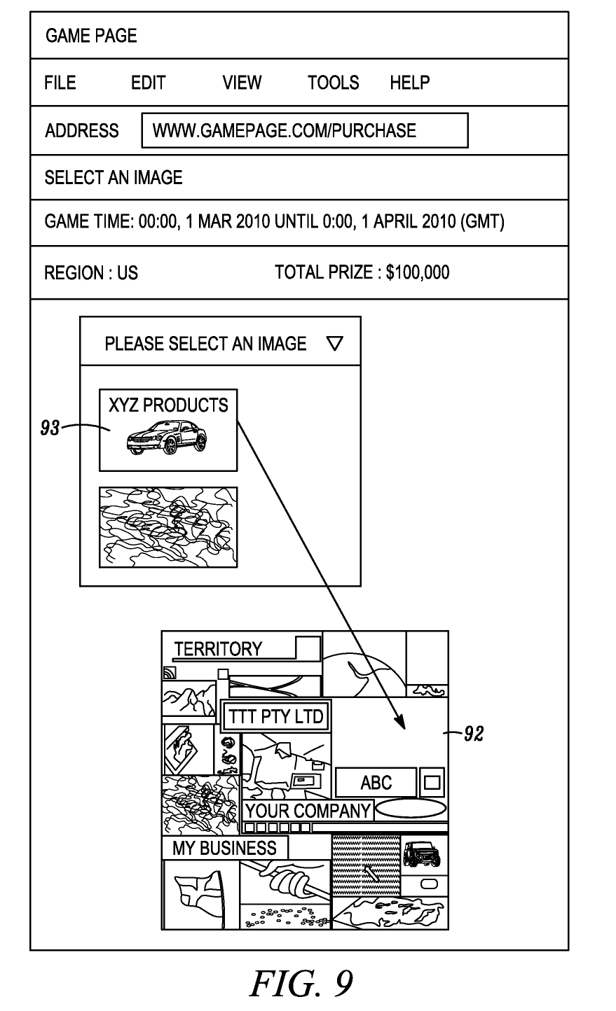

FIG. 9 illustrates a screenshot of the purchasing page of FIG. 6, according to some embodiments. In this example, the content provider (a business trading as “XYZ Products”) visits the game page 90 after all but two of the game spaces have been purchased, as shown in FIG. 9. The content provider selects the game space 92 for purchase and nominates advertising content 93 (an “XYZ Products” logo) for association with the game space 92. At step 70, the advertising content 93 is associated with the game space 92, so that it will be displayed in an interactive object presented to a player of the game. Although this embodiment shows the content provider selecting a particular game space in a grid, in other embodiments, the content provider may, for example, drag advertising content 93 into any empty space in the game page to select the space.

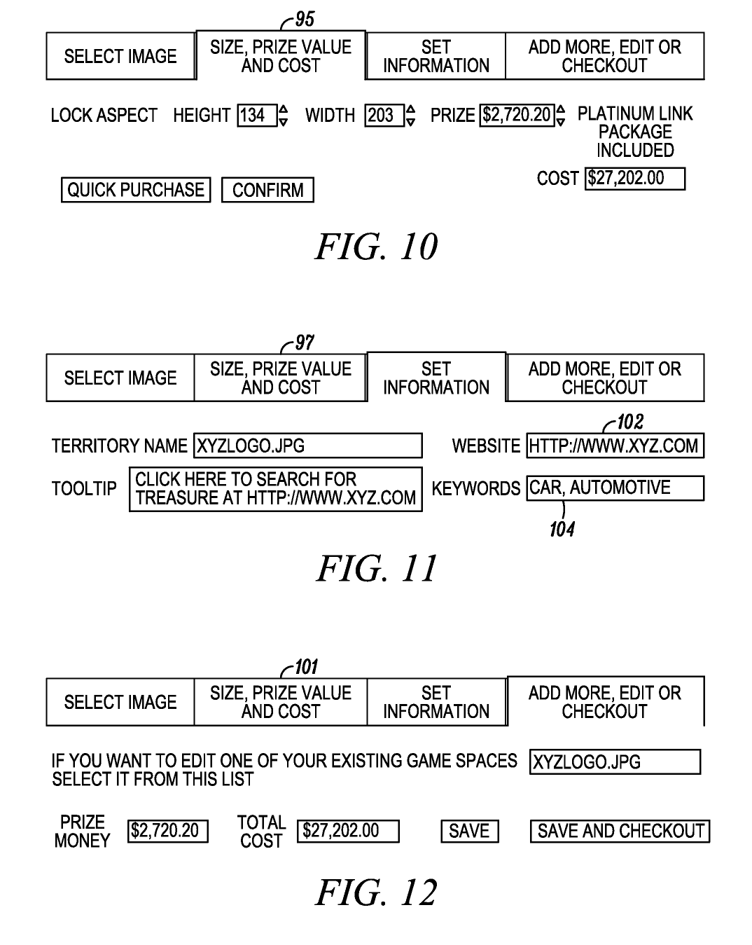

FIG. 10 illustrates a screenshot of a webpage containing options for the content provider, such as a size and a prize value for an interactive object, according to some embodiments. The central controller server 30 then provides a series of options, as shown in FIGS. 10-12. In FIG. 10, the content provider is presented with a webpage 95 for choosing a size and prize value for the interactive object 92. The purchase price of the interactive object 92 may be proportional to the prize value, as shown in this example. In another example, the content provider may increase the prize money by paying more without increasing the size of the game space. This allows the content provider to place an attractive interactive object in games that are almost full. It also allows for a content provider to trick players by hiding a large prize in a small space.

FIG. 11 illustrates a webpage for choosing a name, URL, and the like, according to some embodiments. In FIG. 11, a webpage 97 is shown for choosing a name, URL, tooltip and keywords for associating with the interactive object 92. As shown in FIG. 11, the content provider has nominated the URL “www.xyz.com” 102 as the address of the electronic content and the keywords “car” and “automotive” 104. The name of the interactive object 92 by default is set to the name of the advertising content file 93, and the tooltip is set based on the URL entered. FIG. 12 illustrates a webpage for editing interactive object options, according to some embodiments. As shown in FIG. 12, a webpage 101 provides editing for one or more of the above options, and checking out in order to enter payment details.

At step 72 of FIG. 5, the software associates the electronic content with the interactive object by storing the nominated URL 102. When the user interface environment is presented to a user playing the game, it will include an interactive object that can be selected to cause the electronic content to be delivered to the user. At step 74, the software associates the keywords 104 with the game space 92, to enable users playing the game to search for the game space 92.

At step 76 of FIG. 5, the software associates task elements 112 and 114 with the game space 92. The task elements are for incorporating or embedding in the electronic content for activation by a user to complete a task. The task elements in this example are coded hyperlinks. The task element could alternatively include executable code. Each task element may enable access to a particular task page, such as task page 110 shown in FIG. 7, or with a number or type of task pages. Access to the task page 110 can be handled by the central controller server 30 so that the page source code accessible via the web browser at the client does not reveal the location of the task page 110.

Alternatively, a task element may not be associated with any task pages, but may cause a randomly selected task page to be displayed when it is clicked on. In another alternative, the task element may not be associated with any task pages, and selection of the task element may be enough to complete the task. The task element may exhibit different behaviour at different times.

The task elements may be available in different difficulty categories. For example (going from simplest to most complex) a Bronze task element might lead a user to a crossword type question limited to a short text clue and response, a Silver task element may enable larger text or image based clues (for example, a 3D shape puzzle), a Gold task element could include (in addition to all the options of the Bronze and Silver task elements) video or audio questions (e.g. name a song from a snippet of music or listen to an entire song to get a lyric). Finally, a Platinum task element could hold a full blown game (e.g. chess) that the player would be asked to complete. Content providers may choose to purchase additional task elements or task pages, or more complex task pages. A content provider may also be given the option to purchase special spaces such as the entire background or surrounding border of a game, the banner at the top of the user interface environment, or to set the theme of the game in some other way including the environment, shape or configurations of the user interface environment.

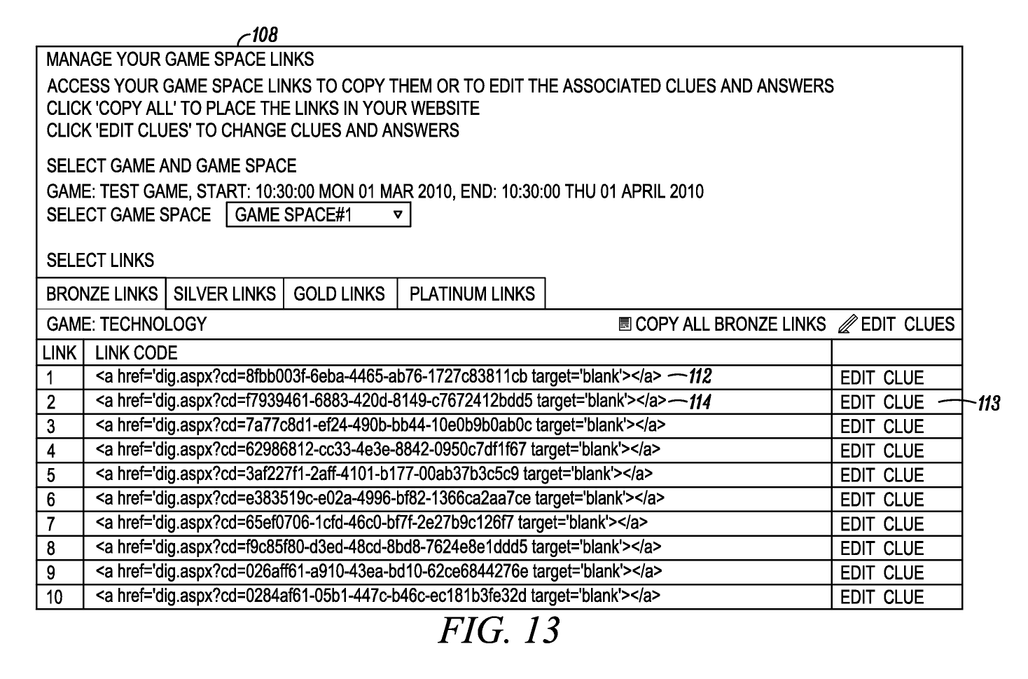

FIG. 13 illustrates a webpage for providing task elements to a content provider, according to some embodiments. At step 78 of FIG. 5, the software provides the task elements 112 and 114 to the content provider that purchased the game space for the content provider to embed in their website. FIG. 13 shows an example webpage 108 for providing task elements 112, 114 (and additional task elements) to the content provider. The content provider may be encouraged to conceal these task elements to make finding them a challenge. Larger/more expensive game spaces may have more associated task elements/task pages and more complex task elements/task pages.

The content provider has the opportunity to modify task pages associated with their task elements at step 80 of FIG. 5. This feature may be accessed by clicking on the “Edit Clue” button associated with the task element on webpage 108 (for example button 113 associated with task element 112). Thus the content provider can tailor the task pages to suit their own specific requirements. This may mean that, for a player to correctly complete the clues, questions, puzzles, tasks or tests of skill, that player can gather information from the content provider's website or some other source nominated by the content provider. The source may, for example, be a hardcopy brochure or business card available at the content provider's store. The software may set a limit on the number of task pages that the content provider can modify, for example to 50% of the task pages allocated to that content provider. In this way, the central controller can retain some control over the level of difficulty of the tasks.

The task page 110 of FIG. 7 may be associated with task elements 112 and 114 provided to the business trading as “XYZ Products” on purchase of the game space 92. The task page 110 may be one of a number of task pages that are displayed randomly on activation of task element 112 or 114. The business trading as “XYZ Products” may view the task page 110 and modify activity instructions on the task page 110 to read “When is the model T being released?” and the activity result associated with the task page 110 to read “1 Apr. 2010”. A user faced with the task could then gather information from the webpage 116 at the URL “wwvv.xyz.com/news” (shown in FIG. 16) in order to complete the task.

### EXAMPLE 6

### Embedding Task Elements

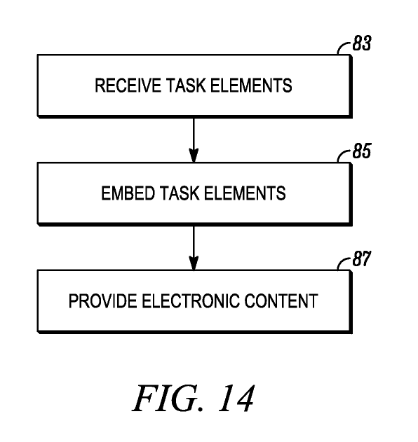

FIG. 14 illustrates a flowchart for receiving and embedding task elements, as well as providing electronic content, according to some embodiments. Referring now to FIG. 14, the content provider that has purchased the interactive object receives the task elements 112 and 114 from the content provider at step 83 and embeds 85 the task elements 112 and 114 into the webpages 100 and 116 at step 85.

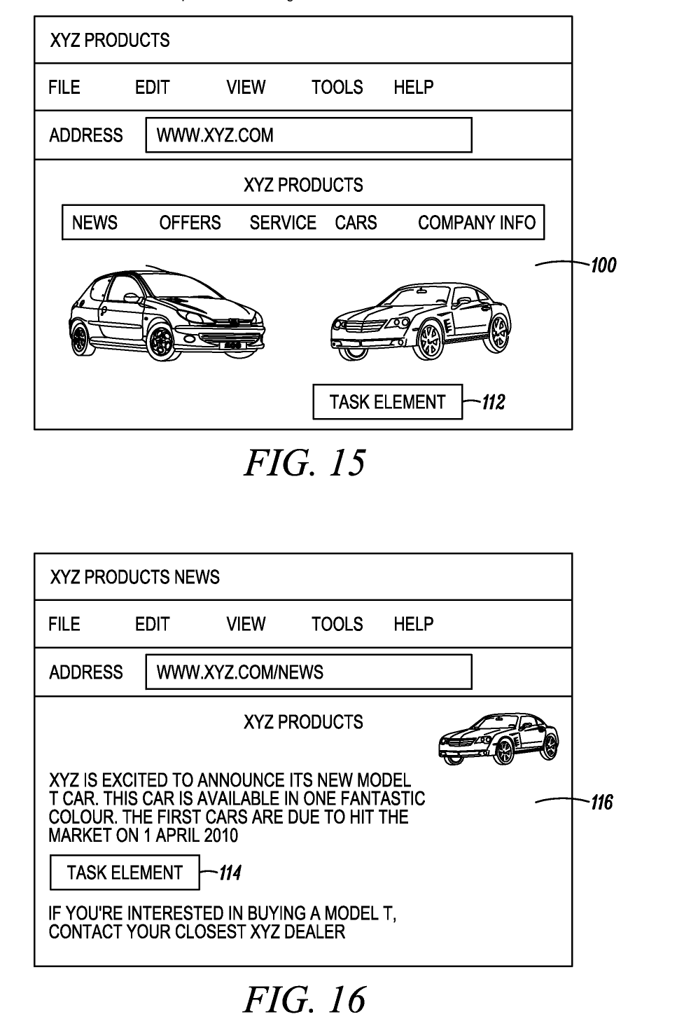

FIGS. 15 and 16 illustrate screenshots of electronic content having task elements embedded in webpages, according to some embodiments. The task elements 112 and 114 are shown embedded in webpages 100 and 116, respectively. Webpages 100 and 116 are part of the same website for the business “XYZ Products”. The task elements 112 and 114 are activatable by a user to complete a task. The webpages 100 and 116 are stored in the database 38 associated with the content provider server 32. The content provider then provides the webpages 100 and 116 to users at step 87.

The content provider may make the task elements 112 and 114 visible and obvious (e.g. “Here is a Game Space Link!!!”) or well hidden. The task elements could be hidden to people casually visiting the content providers' website, or they could be visible only to registered users. If they are visible, a user browsing to the website and selecting the task element may be prompted to register or login.

The content provider may make the task elements part of some text or a tiny area in an image that encourages the user to really study the content to find. Task elements may also be placed inside video presentations or on pages that are only accessible once a user has done some task. Task elements may be held back until any time during the game—then the content provider may activate the task element, and announce it to create more interest. The content provider may include clues of their own like a trail of breadcrumbs to lead the player to task elements.

It will be appreciated that the content provider need not embed the task elements 112 and 114 into webpages, and could instead provide the task elements to users via other means, such as an RSS feed, on a social networking website, via TWITTER, or by embedding the task elements 112 and 114 in any other media including newspapers, videos, business cards or brochures.

### EXAMPLE 7

### Playing the Game

Once a certain number of interactive objects have been purchased, or on the occurrence of another event, a user interface environment may be made available online, for access by a plurality of users wishing to play the game. There can be any number of games running concurrently in the user interface environment. Before putting a game online, the software running on the central controller server 30 may set certain parameters. For example, the software may set a defined period of time in which a game will be made available. This period can be any period of time that may be functional in a particular setting such as, for example, about 30 minutes, about 30 hours, or about 30 days. In some embodiments, the period of time can be about 1 minute, about 5 minutes, about 10 minutes, about 15 minutes, about 20 minutes, about 30 minutes, about 45 minutes, about an hour, or about a day. In some embodiments, the period can range from about 1 hour to about 1 year, from about 1 minute to about 24 hours, from about one day to about one week, from about one week to about 1 month, from about 1 month to about 3 months, or any range therein. And, any combination of time frames from the ranges taught herein can be used in some embodiments, where the combination can also include a random or an unannounced time frame. Announcement, or the lack thereof, of an existing timeframe can have the function of increasing user participation. One of skill will appreciate that virtually any functional period of availability, any combination periods, can be used in some embodiments. The software may set a points system for each interactive object, and each task page. Different tasks may be worth a different number of points depending on their difficulty. Points may be gained for different actions, such as:

first user to use a particular task element;

first user to select a particular interactive object;

speed of completing a task;

difficulty of a task completed;

quality of an answer given in completion of a task;

type of task;

number of users who have previously used a particular task element; and

number of users who have previously used any task element associated with the interactive object.

The software may also set a reward for each interactive object, and criteria for gaining the reward. The reward may be a monetary amount proportional to the purchase price of the interactive object, such as 10% of the purchase price. The criteria may be the user with the highest points score for the interactive object after the defined period of time. Information about the rewards may be made available to users, or it may be kept secret until the defined period of time has passed, or an action has been completed, for example, or any other event has occurred. In some embodiments, the period or action can be announced randomly, with or without prior warning to increase user interest in increased play.

The software may also set a variety of special bonus prizes, such as a prize for a user with the highest points score for the highest number of interactive objects in the user interface environment, or a prize for the user who successfully completed the most tasks, or completed the most tasks within the shortest time. Other special prizes may include a special prize for students or a donation to charity. Awarding prizes/rewards to users who win the highest number of interactive objects (rather than the largest) may make the smaller interactive objects more attractive. There may be social group, local, city, state, regional and global championship ladders that include a prize to the top players after a period of time.

It is envisaged that user interface environments could be provided via several different sites in different regions and languages so that, for example, a user navigating to a user interface environment in the US would see a different site that a user in Australia and different again to a user accessing a user interface environment from the UK.

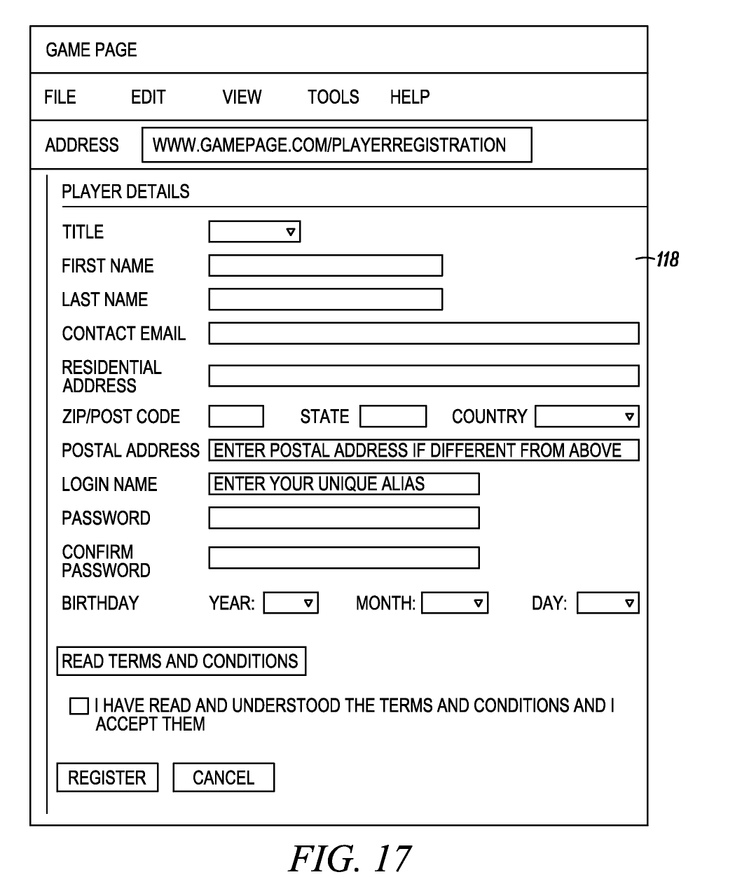

FIG. 17 illustrates a registration page for a user of a game, according to some embodiments. A user who wishes to play the game may access the website of the central controller server 30 using a web browser on their personal computer 24. The user may register as a player using registration webpage 118 shown in FIG. 17. The central controller server 30 may then provide the user with a user interface environment—a webpage or webpages enabling the user to play a game of interest. The webpages may provide the user with information about current games. This information may be filtered or ordered according to the user's physical location, their demographic information or the player's own preferences. For example, the user may search keywords and classifications allocated to games and interactive objects by the content provider, and the keywords and URLs provided by the content providers that purchased interactive objects. The games may be displayed in ranked order according to the match with the keywords provided by the user. The user may then select which game(s) to play and access the game page of each of those games.

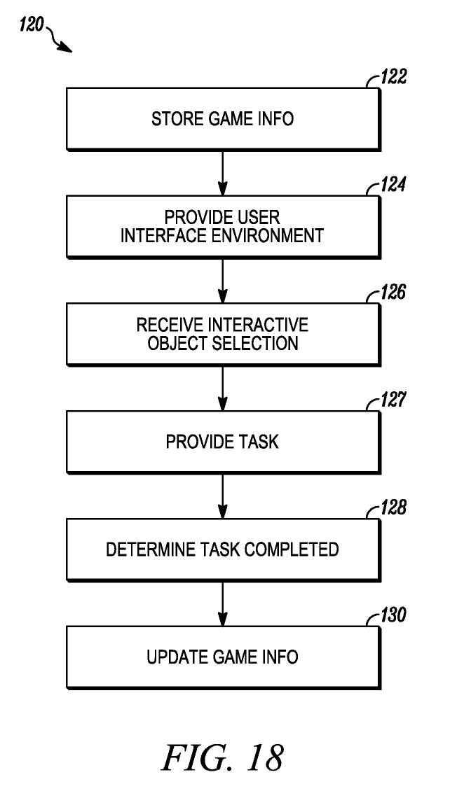

FIG. 18 illustrates a flowchart for use of the systems provided herein, according to some embodiments. With reference to FIG. 18, the software at the central controller server 30 may include a series of instructions for performing a method 120. At step 122, game information is stored, as described above. At step 124, the user is provided with a user interface environment, for example user interface environment 119. As shown in FIG. 11, the user interface environment 119 includes a number of interactive objects that have been purchased by different content providers. The purchasing content provider's logo or some other image, video or other media selected by the purchasing content provider is displayed in each interactive object. For example, the “XYZ Products” logo is displayed in interactive object 121.

The player may select the interactive object 121, for example by clicking on the object 121 or hovering over the object 121. The player may or may not know if the interactive object is already claimed, how strongly it is held or how much reward it holds. They may be provided with this information only after attempting to claim the interactive object by completing tasks. In the case of the amount of prize money/reward they may be asked to actually have the most points at some stage of the game and so be the ‘Owner’ of an interactive object before they find out how much it is worth.

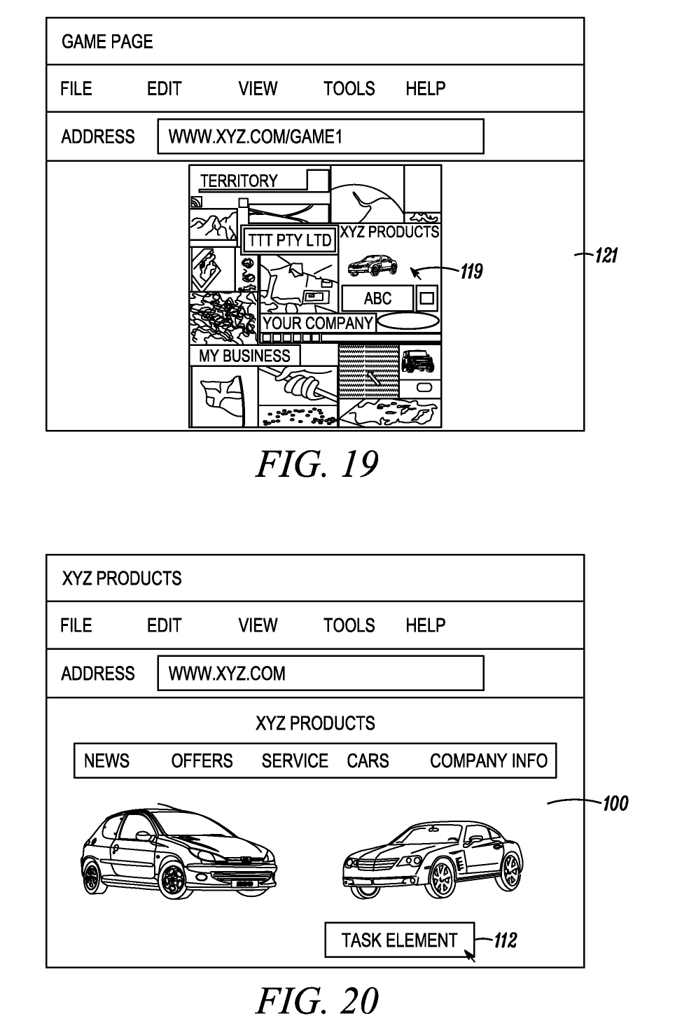

FIG. 19 illustrates a game space of interactive objects, according to some embodiments. Selecting the user interactive object 119, as shown in FIG. 19, causes the software at the central controller server 30 to receive an interactive object selection at step 126. This causes the webpage 100 (associated with interactive object 92) to be delivered to the user. FIG. 20 illustrates a screenshot of the electronic content of a webpage relating to the selection of an interactive object, according to some embodiments. The webpage 100 is then displayed in the user's web browser.

The user may then search the webpage 100 for task elements. The user may also be directed to search other webpages, for example, that are part of the same website. Webpages 100 and 116 may include hints or clues to assist the user to find the task elements. For example, the clue may direct the user to a particular webpage, or to information about a particular product or service described on the website.

When a user selects an interactive object, the user's web browser may send referrer information to the content provider server 32, for example in the header of a HTTP request. It may also send cookies or other identifiers of the user. This notifies the content provider server 32 that the user is a player of the game, and enables the content provider to gather information such as how long the user spent on the content provider's website before they found a task element. The software at the central controller server 30 may record a user selecting an interactive object and the user's attempts to complete tasks. Reports and statistics may be provided to the content provider to enable them to measure the effectiveness of the interactive object.

In this embodiment, when a user selects task element 112, as shown in FIG. 20, the software provides a task at step 127, by generating the task page 110 for access by the user. Task page 110 is displayed in a separate browser window, as shown in FIG. 7. In an alternative embodiment, activation of the task element 112 may cause the task page 110 to pop up in the electronic content 100 or in the user interface environment 119. Alternatively, a separate popup or browser window could provide information to lead the player to the task.

The user then completes the task “When is the model T being released'?” defined by the activity instructions on the task page 110. In this case, the user enters the activity result “1 Apr. 2010” in order to complete the task. The user may be asked to refer to webpage 116 in order to obtain the correct answer. The software at the central controller server 30 determines that the user has completed the task at step 128. For example, a code may be sent to the server 30 when the user enters the correct activity result. The user may receive some indication of success or failure and also some indication of whether they had ‘claimed’ the interactive object 121 at that point.

At step 130, the software on the central controller server 30 updates the game information, including the status information associated with the interactive object 121 to record a points score for the user (as identified by their user name). For example, the first user to select interactive object 121, activate task element 112 and enter the correct activity result may be awarded 300 points—100 points for being the first to select the interactive object, 100 points for being the first to activate task element 112, and 100 points for the correct activity result. The second user to perform these steps may be awarded only 100 points, for entering the correct activity result. However, if the second user is the first to access another task element, such as task element 114, the second user may be awarded a further 250 points—100 points for being the first to access task element 114, and say 150 points for the correct activity result for a task associated with task element 114. This gives the second user a total of 350 points, 50 points more than the first user.

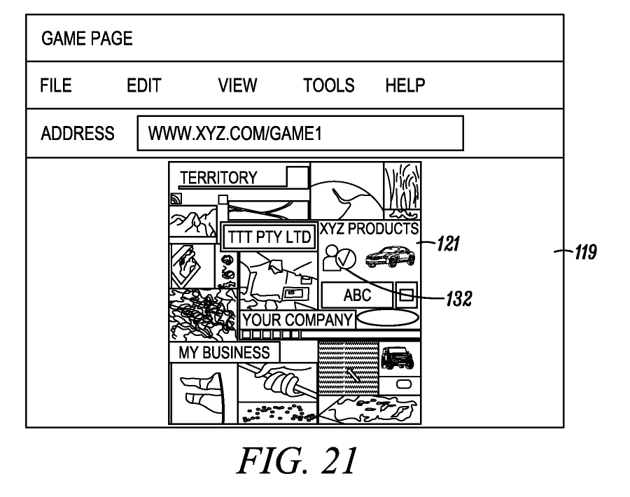

FIG. 21 illustrates how the system may show a particular user that has achieved the highest points in a particular game, according to some embodiments. A representation 132 of the user having the highest points score for the interactive object 119 may be displayed on the interactive object 119, as shown in FIG. 21. There may be any number of users competing for a particular interactive object throughout a game and a particular space may change hands between many different users during the defined time period for the game. After the defined time period has expired, the software awards the reward for each interactive object to the user with the highest points score for that interactive object.

The teachings herein are not intended to be limited to any particular computer or other apparatus. Various general purpose systems may be used with the teachings herein, and a specialized apparatus may also be used, in some embodiments. No particular programming language is intended. The terms used to describe systems, methods, and apparatus are not intended to be limiting. Some terms describe a functional component of the systems, methods, and apparatus. A functional component, for example, can be used to separate an individual individual function from other components, or functions can be combined into a single component in some embodiments. For example, the term “module” can represent a functional component having one or more functions in some embodiments. The same can be true for the term “engine” and the like. Terms such as “embodiment,” or “example,” indicate non-limiting illustrations for the teachings presented herein.

We claim:

1. A multi-incentive method of distributing marketing material to a user, the method comprising:
creating a game for a user to play based on understanding at least a substantial amount of a marketing material, wherein the game is a first incentive for the user to view the marketing material in detail;
adding a competitive element to the game as a second incentive for the user to view the marketing material in detail;
adding a social element to the game as a third incentive; and
providing a reward to the user for a performance in the competition as a fourth incentive for the user to view the marketing material in detail;
wherein, the first, second, third, and fourth incentives encourage the user to view and understand at least the substantial amount of the marketing material.

2. The method of claim 1, wherein the game is designed for a particular demographic predisposed to an interest in a product or service in the marketing material.

3. The method of claim 1, wherein the competitive element includes an interactive environment that includes additional users in the competition.

4. The method of claim 1, wherein the competition includes an online environment.

5. The method of claim 1, wherein the competition includes an MMO environment.

6. The method of claim 1, wherein the reward comprises a value relating to a product or a service marketed in the game.

7. The method of claim 1, wherein the method further comprises a blog or chatroom for users.

8. The method of claim 1, wherein the competition is coupled to a social networking environment.

9. A system for a multi-incentive distribution of a marketing material to a user, the system comprising:
an input device;
a processor;
a user-profile module embodied in a non-transitory computer readable storage medium for obtaining answers to questions from a user to establish a user profile for use in identifying the user's demographic;
a system database embodied in a non-transitory computer readable storage medium for storing a user profile and a marketing material used in a competitive, social, and reward-based game for a user to play based on understanding at least a substantial amount of the marketing material, wherein the game is a first incentive, the competition is a second incentive, the social aspect is a third incentive, and the reward is a fourth incentive, for the user to view the marketing material in detail;
a solutions module embodied in a non-transitory computer readable storage medium for identifying a user profile corresponding to the marketing material;
an integration engine embodied in a non-transitory computer readable storage medium for matching the user demographic from the user profile to the marketing material;
an alignment module embodied in a non-transitory computer readable storage medium for aligning the user to the competitive reward-based game;
a gaming module embodied in a non-transitory computer readable storage medium for implementing the game;
an output module embodied in a non-transitory computer readable storage medium;
wherein, the first, second, third, and fourth incentives encourage the user to view and understand at least the substantial amount of the marketing material.

10. The system of claim 9, wherein the system further comprises a browser module.

11. The system of claim 9, wherein the system further comprises an external database.

12. The system of claim 9, wherein the system further comprises a multilanguage database and translation engine.

13. The system of claim 9, wherein the game is designed for a particular demographic predisposed to an interest in a product or service in the marketing material.

14. The system of claim 9, wherein the competitive element includes an interactive environment that includes additional users in the competition.

15. The system of claim 9, wherein the competition includes an online environment.

16. The system of claim 9, wherein the competition includes an MMO environment.

17. The system of claim 9, wherein the reward comprises a value relating to a product or a service marketed in the game.

18. The system of claim 9, wherein the method further comprises a blog or chatroom for users.

19. The system of claim 9, wherein the competition is coupled to a social networking environment.

20. A system for inducing an interest in a user in a marketing material, the system comprising:
a game component comprising an core activity in which a user can participate, the core activity based on understanding at least a substantial amount of a marketing material;
a competition component in which the user's performance is compared to the performance of another user;
a social component in which the user can communicate with another user having similar interests; and, a reward component in which the user receives a reward based on the user achieving a desired level of performance.
